(19) United States
(12) Patent Application Publication
(10) Pub. No.: US 2026/0222556 A1
(43) Pub. Date: Jul. 30, 2026

(54) VIDEO CODING METHOD AND APPARATUS OF CHROMA PREDICTION

(71) Applicant: MEDIATEK INC., Hsin-Chu (TW)

(72) Inventors: Man-Shu Chiang, Hsinchu City (TW); Chia-Ming Tsai, Hsinchu City (TW); Chih-Wei Hsu, Hsinchu City (TW)

(73) Assignee: MEDIATEK INC., Hsin-Chu (TW)

(21) Appl. No.: 19/148,313

(22) PCT Filed: Jan. 16, 2024
(86) PCT No.: PCT/CN2024/072582

§ 371 Date: Jul. 15, 2025

Related U.S. Application Data
(60) Provisional application No. 63/439,257, filed on Jan. 16, 2023.

(51) Int. Cl. H04N 19/109; H04N 19/176; H04N 19/186; H04N 19/51; H04N 19/70

(52) U.S. Cl. CPC H04N 19/109; H04N 19/176; H04N 19/186; H04N 19/51; H04N 19/70

(57) ABSTRACT

A method for video coding includes: receiving data to be encoded or decoded as a current block of pixels of a current picture of a video, wherein the current block includes at least one chroma block; and encoding or decoding the current block by a target inter prediction mode, which includes: obtaining a motion compensation predictor of a chroma sample included in the at least one chroma block; obtaining at least one cross-component predictor of the chroma sample; and determining inter prediction of the chroma sample by jointly considering the motion compensation predictor and the at least one cross-component predictor.

This application claims the benefit of U.S. provisional application No. 63/439,257, filed on Jan. 16, 2023.

### BACKGROUND OF THE INVENTION

### 1. Field of the Invention

The present invention relates to video coding, and more particularly, to a video coding method that determines inter prediction of a chroma sample by jointly considering (e.g., blending) a motion compensation predictor (i.e. an inter-predicted chroma sample) and at least one cross-component predictor (i.e., one or more cross-component intra-predicted chroma sample) and an associated apparatus.

### 2. Description of the Prior Art

The conventional video coding standards generally adopt a block based coding technique to exploit spatial and temporal redundancy. For example, the basic approach is to divide the whole source picture into a plurality of blocks, perform intra/inter prediction on each block, transform residues of each block, and perform quantization and entropy encoding. Besides, a reconstructed picture is generated in a coding loop to provide reference data used for coding following blocks. For certain video coding standards, in-loop filter(s) may be used for enhancing the image quality of the reconstructed frame.

The video decoder is used to perform an inverse operation of a video encoding operation performed by a video encoder. For example, the video decoder may have a plurality of processing circuits, such as an entropy decoding circuit, an intra prediction circuit, a motion compensation circuit, an inverse quantization circuit, an inverse transform circuit, a reconstruction circuit, and in-loop filter(s).

Typically, for an inter block, chroma prediction may be not as accurate as luma prediction. For example, motion vectors for chroma samples are inherited from luma samples in the same coding unit. That is, the chroma samples may not have their own motion vectors. Thus, there is a need for an innovative inter chroma prediction scheme for improving the inter chroma prediction accuracy as well as the coding efficiency.

### SUMMARY OF THE INVENTION

One of the objectives of the claimed invention is to provide a video coding method that determines inter prediction of a chroma sample by jointly considering (e.g., blending) a motion compensation predictor (i.e. an inter-predicted chroma sample) and at least one cross-component predictor (i.e. one or more cross-component intra-predicted chroma sample) and an associated apparatus.

According to a first aspect of the present invention, an exemplary method for video coding is disclosed. The exemplary method includes: receiving data to be encoded or decoded as a current block of pixels of a current picture of a video, wherein the current block comprises at least one chroma block; and encoding or decoding the current block by a target inter prediction mode, which includes: obtaining a motion compensation predictor of a chroma sample included in the at least one chroma block; obtaining at least one cross-component predictor of the chroma sample; and determining inter prediction of the chroma sample by jointly considering the motion compensation predictor and the at least one cross-component predictor.

According to a second aspect of the present invention, an exemplary video encoder is disclosed. The exemplary video encoder includes a video data memory and an encoding circuit. The video data memory is arranged to receive data to be encoded as a current block of pixels of a current picture of a video, wherein the current block comprises at least one chroma block. The encoding circuit is arranged to perform encoding of the current block by a target inter prediction mode. The encoding circuit includes a motion compensation circuit and an inter chroma prediction circuit. The motion compensation circuit is arranged to obtain a motion compensation predictor of a chroma sample included in the at least one chroma block. The inter chroma prediction circuit is arranged to obtain at least one cross-component predictor of the chroma sample, and determine inter prediction of the chroma sample by jointly considering the motion compensation predictor and the at least one cross-component predictor.

According to a third aspect of the present invention, an exemplary video decoder is disclosed. The exemplary video decoder includes a video data memory and a decoding circuit. The video data memory is arranged to receive data to be decoded as a current block of pixels of a current picture of a video, wherein the current block comprises at least one chroma block. The decoding circuit is arranged to perform decoding of the current block by a target inter prediction mode. The decoding circuit includes a motion compensation circuit and an inter chroma prediction circuit. The motion compensation circuit is arranged to obtain a motion compensation predictor of a chroma sample included in the at least one chroma block. The inter chroma prediction circuit is arranged to obtain at least one cross-component predictor of the chroma sample, and determine inter prediction of the chroma sample by jointly considering the motion compensation predictor and the at least one cross-component predictor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an example of four reference lines neighboring to a prediction block according to an embodiment of the present invention.

FIG. 2 is a diagram illustrating locations of the samples used for the derivation of α and β according to an embodiment of the present invention.

FIG. 3 is a diagram illustrating an example of classifying the neighboring samples into two groups according to an embodiment of the present invention.

FIG. 4 is a diagram illustrating the effect of the slope adjustment parameter “u” according to an embodiment of the present invention.

FIG. 5 is a diagram illustrating a spatial part of the convolutional filter according to an embodiment of the present invention.

FIG. 6 is a diagram illustrating a reference area (with its paddings) used to derive the filter coefficients according to an embodiment of the present invention.

FIG. 7 is a diagram illustrating 16 gradient patterns for GLM according to an embodiment of the present invention.

FIG. 8 is a diagram illustrating that IBC in VVC allows only the reconstructed portion of the predefined area including the region of current CTU and some region of the left CTU according to an embodiment of the present invention.

FIG. 9 is a diagram illustrating HoG computation from a template of width 3 pixels according to an embodiment of the present invention.

FIG. 10 is a diagram illustrating prediction fusion by weighted averaging of two HoG modes and planar according to an embodiment of the present invention.

FIG. 11 is a diagram illustrating a template and its reference samples used in TIMD according to an embodiment of the present invention.

FIG. 12 is a diagram illustrating positions of spatial merge candidate according to an embodiment of the present invention.

FIG. 13 is a diagram illustrating candidate pairs considered for redundancy check of spatial merge candidates according to an embodiment of the present invention.

FIG. 14 is a diagram illustrating spatial neighboring blocks used to derive the spatial merge candidates according to an embodiment of the present invention.

FIG. 15 is a diagram illustrating motion vector scaling for temporal merge candidate.

FIG. 16 is a diagram illustrating candidate positions for temporal merge candidate, C₀ and C₁, according to an embodiment of the present invention.

FIG. 17 is a diagram illustrating top and left neighboring blocks used in CIIP weight derivation according to an embodiment of the present invention.

FIG. 18 is a diagram illustrating examples of the GPM splits grouped by identical angles according to an embodiment of the present invention.

FIG. 19 is a diagram illustrating uni-prediction MV selection for geometric partitioning mode according to an embodiment of the present invention.

FIG. 20 is a diagram illustrating exemplified generation of a blending weight W0 of GPM according to an embodiment of the present invention.

FIG. 21 is a diagram illustrating the ramp function for the weight of GPM derived based on the displacement from a sample position to the GPM partition boundary and the fixed threshold t according to an embodiment of the present invention.

FIG. 22 is a diagram illustrating GPM blending in the current ECM 4.0 according to an embodiment of the present invention.

FIG. 23 is a diagram illustrating exemplified generation of a bending weight w₀ using geometric partitioning mode according to an embodiment of the present invention.

FIG. 24 is a diagram illustrating GPM with inter and intra prediction (or named GPM intra) according to an embodiment of the present invention.

FIG. 25 is a diagram illustrating Spatial GPM (SGPM) consisting of one partition mode and two associated intra prediction modes according to an embodiment of the present invention.

FIG. 26 is a diagram illustrating SGPM signaling according to an embodiment of the present invention.

FIG. 27 is a diagram illustrating template shape and extended weight according to an embodiment of the present invention.

FIG. 28 is a diagram illustrating a linear predicting method of linearly predicting chroma samples from luma samples according to an embodiment of the present invention.

FIG. 29 is a diagram illustrating an example of subblock based decision according to an embodiment of the present invention.

FIG. 30 is a diagram illustrating that inter-predictor of regular merge mode is refined using the above R_{x, -1} and left R_{-1,y} reconstructed samples according to an embodiment of the present invention.

FIG. 31 is a diagram illustrating that a boundary matching cost for a candidate mode refers to the discontinuity measurement (including top boundary matching and/or left boundary matching) between the current prediction (the predicted samples within the current block), generated from the candidate mode, and the neighboring reconstruction (the reconstructed samples within one or more neighboring blocks) according to an embodiment of the present invention.

FIG. 32 is a diagram illustrating scanning orders when adding the spatial model information from spatial neighbour blocks into the list according to an embodiment of the present invention.

FIG. 33 is a diagram illustrating an example of the right-bottom region for the current chroma block according to an embodiment of the present invention.

FIG. 34 is a block diagram illustrating a video encoder that supports the proposed inter chroma prediction mode according to an embodiment of the present invention.

FIG. 35 is a block diagram illustrating a video decoder that supports the proposed inter chroma prediction mode according to an embodiment of the present invention.

FIG. 36 is a flowchart illustrating a video coding method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

### Acronyms

CCLM: Cross Component Linear Model
MMLM: Multiple model CCLM
LM: Linear Model
MV: Motion Vector
CU: Coding Unit
CB: Coding Block
CTU: Coding Tree Unit
VVC: Versatile Video Coding
SAO: Sample Adaptive Offset
ALF: Adaptive Loop Filtering
IBC: Intra Block Copy
MRL: Multiple reference line
ISP: Intra sub-partitions
MIP: Matrix weighted Intra Prediction
JCCR: Joint Coding of Chroma Residual
   Intra Mode Coding with 67 Intra Prediction Modes

To capture the arbitrary edge directions presented in natural video, the number of directional intra modes in VVC is extended from 33, as used in HEVC, to 65.

To keep the complexity of the most probable mode (MPM) list generation low, an intra mode coding method with 6 MPMs is used by considering two available neighboring intra modes. The following three aspects are considered to construct the MPM list:
Default intra modes
Neighbouring intra modes
Derived intra modes

### Multiple Reference Line Intra Prediction

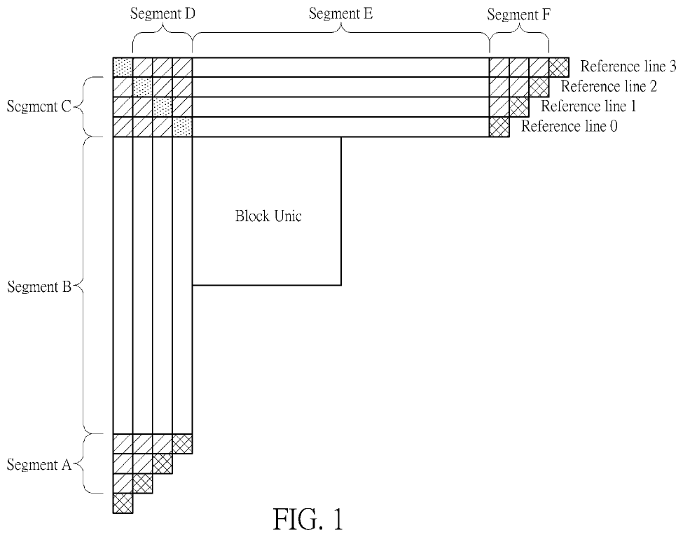

Multiple reference line (MRL) intra prediction uses more reference lines for intra prediction. In FIG. 1, an example of 4 reference lines is depicted, where the samples of segments A and F are not fetched from reconstructed neighbouring samples but padded with the closest samples from Segment B and E, respectively. HEVC intra-picture prediction uses the nearest reference line (i.e., reference line 0). In MRL, 2 additional lines (reference line 1 and reference line 3) are used.

The index of selected reference line (mrl_idx) is signalled and used to generate intra predictor. For the reference line index, which is greater than 0, only include additional reference line modes in MPM list and only signal the MPM index without remaining modes. The reference line index is signalled before intra prediction modes, and Planar mode is excluded from intra prediction modes in case a nonzero reference line index is signalled.

MRL is disabled for the first line of blocks inside a CTU to prevent using extended reference samples outside the current CTU line. Also, PDPC is disabled when additional line is used. For MRL mode, the derivation of DC value in DC intra prediction mode for non-zero reference line indices is aligned with that of reference line index 0. MRL requires the storage of 3 neighboring luma reference lines with a CTU to generate predictions. The Cross-Component Linear Model (CCLM) tool also requires 3 neighboring luma reference lines for its downsampling filters. The definition of MRL to use the same 3 lines is aligned with CCLM to reduce the storage requirements for decoders.

### Cross-Component Linear Model Prediction

To reduce the cross-component redundancy, a cross-component linear model (CCLM) prediction mode (or named as LM) is used in the VVC, for which the chroma samples are predicted based on the reconstructed luma samples of the same or collocated CU by using a linear model as follows:

$${pred}_{C} ( i , j ) = α \cdot {rec}_{L}^{′} ( i , j ) + β \qquad ( 1 )$$

where pred_{C}(i,j) represents the predicted chroma samples in a CU and rec_{L}′(i,j) represents the downsampled reconstructed luma samples of the same or collocated CU.

One example is that the CCLM parameters (α and β) are derived with at most four neighbouring chroma samples and their corresponding down-sampled luma samples. Suppose the current chroma block dimensions are W×H, then W″ and H′ are set as
W′=W, H′=H when LM_LA mode is applied;
W′=W+H when LM_A mode is applied;
H′=H+W when LM_L mode is applied;

The above neighbouring positions are denoted as S[0, −1] . . . . S[W′−1, −1] and the left neighbouring positions are denoted as S[−1, 0] . . . . S[−1, H′−1]. Then the four samples are selected as
S[W′/4, −1], S[3*W′/4, −1], S[−1, H′/4], S[−1, 3*H′/4] when LM LA mode is applied and both above and left neighbouring samples are available;
S[W′/8, −1], S[3*W/8, −1], S[5*W′/8, −1], S[7*W′/8, −1] when LM_A mode is applied or only the above neighbouring samples are available;
S[−1, H′/8], S[−1, 3*H′/8], S[−1, 5*H′/8], S[−1, 7*H′/8] when LM_L mode is applied or only the left neighbouring samples are available;

The four neighbouring luma samples at the selected positions are down-sampled and compared four times to find two larger values: x⁰_{A} and x¹_{A}, and two smaller values: x⁰_{B} and x¹_{B}. Their corresponding chroma sample values are denoted as y⁰_{A}, y¹_{A}, y⁰_{B} and y¹_{B}. Then Xₐ, X_{b}, Yₐ and Y_{b} are derived as:

$${X}_{a} = ( {x}_{A}^{0} + {x}_{A}^{1} + 1 ) ≫ 1 ; {X}_{b} = ( {x}_{B}^{0} + {x}_{B}^{1} + 1 ) ≫ 1 ; {Y}_{a} = ( {y}_{A}^{0} + {y}_{A}^{1} + 1 ) ≫ 1 ; {Y}_{b} = ( {y}_{B}^{0} + {y}_{B}^{1} + 1 ) ≫ 1 \qquad ( 2 )$$

Finally, the linear model parameters α and β are obtained according to the following equations.

$$α = \frac{{Y}_{a} - {Y}_{b}}{{x}_{a} - {x}_{b}} \qquad ( 3 )$$

$$β = {Y}_{b} - α \cdot {X}_{b} \qquad ( 4 )$$

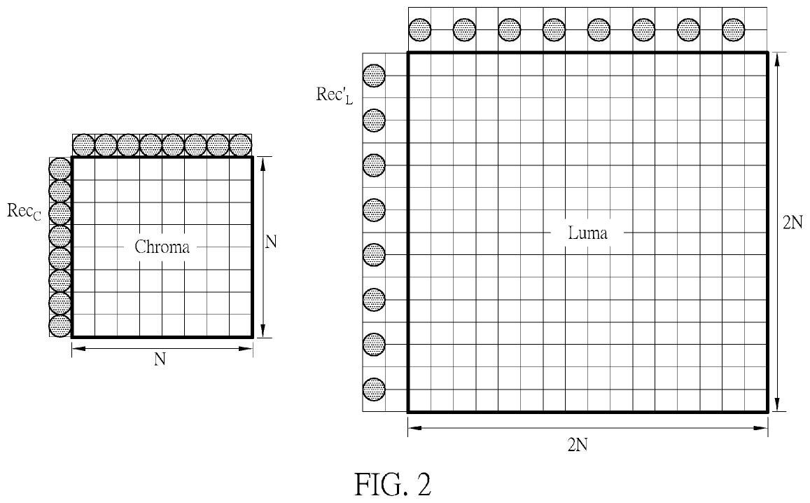

FIG. 2 shows an example of the location of the left and above samples and the sample of the current block involved in the LM_LA mode. CCLM in this invention can use the mentioned example and/or CCLM in this invention is not limited to the mentioned example.

The division operation to calculate parameter α is implemented with a look-up table. To reduce the memory required for storing the table, the diff value (difference between maximum and minimum values) and the parameter α are expressed by an exponential notation. For example, diff is approximated with a 4-bit significant part and an exponent. Consequently, the table for 1/diff is reduced into 16 elements for 16 values of the significand as follows:

$$DivTable [ ] = \{ 0 , 7 , 6 , 5 , 5 , 4 , 4 , 3 , 3 , 2 , 2 , 1 , 1 , 1 , 1 , 0 \} \qquad ( 5 )$$

This would have a benefit of both reducing the complexity of the calculation as well as the memory size required for storing the needed tables. This memory reduction method can be used for CCLM and/or this memory reduction method is not limited to CCLM and can be used for any cross-component mode to reduce the complexity of the calculation.

Besides the above template and left template can be used to calculate the linear model coefficients together, they also can be used alternatively in the other 2 LM modes, called LM_A, and LM_L modes.

In LM_A mode, only the above template is used to calculate the linear model coefficients. To get more samples, the above template is extended to (W+H) samples. In LM_L mode, only left template are used to calculate the linear model coefficients. To get more samples, the left template is extended to (H+W) samples.

In LM_LA mode, left and above templates are used to calculate the linear model coefficients.

To match the chroma sample locations for 4:2:0 video sequences, in some examples, two types of downsampling filter are applied to luma samples to achieve 2 to 1 downsampling ratio in both horizontal and vertical directions. The selection of downsampling filter is specified by a SPS level flag. The two downsmapling filters are as follows, which are corresponding to “type-0” and “type-2” content, respectively.

$${rec}_{L}^{′} ( i , j ) = [ \begin{matrix}{rec}_{L} ( 2 i - 1 , 2 j - 1 ) + 2 \cdot {rec}_{L} ( 2 i - 1 , 2 j - 1 ) + \\ {rec}_{L} ( 2 i + 1 , 2 j - 1 ) + {rec}_{L} ( 2 i - 1 , 2 j ) + \\ 2 \cdot {rec}_{L} ( 2 i , 2 j ) + {rec}_{L} ( 2 i + 1 , 2 j ) + 4\end{matrix} ] ≫ 3 \qquad ( 6 )$$

$${rec}_{L}^{′} ( i , j ) = [ \begin{matrix}{rec}_{L} ( 2 i , 2 j - 1 ) + {rec}_{L} ( 2 i - 1 , 2 j ) + 4 \cdot {rec}_{L} ( 2 i , 2 j ) + \\ {rec}_{L} ( 2 i + 1 , 2 j ) + {rec}_{L} ( 2 i , 2 j + 1 ) + 4\end{matrix} ] ≫ 3 \qquad ( 7 )$$

Note that only one luma line (general line buffer in intra prediction) is used to make the downsampled luma samples when the upper reference line is at the CTU boundary. The downsampling filter can be from the mentioned example and/or is not limited to the mentioned example.

This parameter computation is performed as part of the decoding process, and is not just as an encoder search operation. As a result, no syntax is used to convey the α and β values to the decoder.

For chroma intra mode coding, in one example, a total of 8 intra modes are allowed for chroma intra mode coding. Those modes include five traditional intra modes and three cross-component linear model modes (LM_LA, LM_A, and LM_L). Chroma mode signalling and derivation process are shown in Table 1-1. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the center position of the current chroma block is directly inherited.

TABLE 1-1
Derivation of chroma prediction mode
from luma mode when cclm_is enabled

| | Corresponding luma intra prediction mode | | | | |
|---|---|---|---|---|---|
| | | | | | X |
| Chroma prediction mode | 0 | 50 | 18 | 1 | (0 <= X <= 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

A single binarization table is used regardless of the value of sps_cclm_enabled_flag as shown in Table 1-2.

TABLE 1-2
Unified binarization table for chroma prediction mode

| Value of intra_chroma_pred_mode | Bin string |
|---|---|
| 4 | 00 |
| 0 | 0100 |
| 1 | 0101 |
| 2 | 0110 |
| 3 | 0111 |
| 5 | 10 |
| 6 | 110 |
| 7 | 111 |

In Table 1-2, the first bin indicates whether it is regular (0) or CCLM modes (1). If it is CCLM mode, then the next bin indicates whether it is LM_LA (0) or not. If it is not LM_LA, next 1 bin indicates whether it is LM_L (0) or LM_A (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bins in Table 1-2 are context coded with its own context model, and the rest bins are bypass coded. The chroma intra mode coding can use this example and/or the chroma intra mode coding is not limited to this example.

In addition, in one example, in order to reduce luma-chroma latency in dual tree, when the 64×64 luma coding tree node is partitioned with Not Split (and ISP is not used for the 64×64 CU) or QT, the chroma CUs in 32×32/32×16 chroma coding tree node are allowed to use CCLM in the following way:
If the 32×32 chroma node is not split or partitioned QT split, all chroma CUs in the 32×32 node can use CCLM
If the 32×32 chroma node is partitioned with Horizontal BT, and the 32×16 child node does not split or uses Vertical BT split, all chroma CUs in the 32×16 chroma node can use CCLM.

In all the other luma and chroma coding tree split conditions, CCLM is not allowed for chroma CU.

### Multiple Model CCLM

In the JEM, multiple model CCLM (MMLM) mode is proposed for using two models for predicting the chroma samples from the luma samples for the whole chroma CU/CB. In MMLM, neighbouring luma samples and neighbouring chroma samples of the current block are classified into two groups, each group is used as a training set to derive a linear model (i.e., a particular α and β are derived for a particular group). Furthermore, the samples of the current luma block are also classified based on the same rule for the classification of neighbouring luma samples.

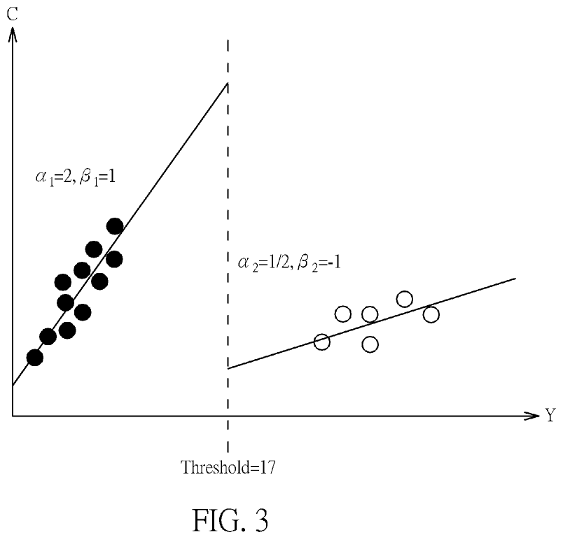

FIG. 3 shows an example of classifying the neighbouring samples into two groups. Threshold is calculated as the average value of the neighbouring reconstructed luma samples or a pre-defined value. A neighbouring sample with Rec′_{L}[x,y]<=Threshold is classified into group 1; while a neighbouring sample with Rec′_{L}[x,y]>Threshold is classified into group 2.

$$\{ \begin{matrix}{Pred}_{C} [ x , y ] = {α}_{1} \times {Rec}_{L}^{′} [ x , y ] + {β}_{1} & if {Rec}_{L}^{′} [ x , y ] \leq Threshold \\ {Pred}_{C} [ x , y ] = {α}_{2} \times {Rec}_{L}^{′} [ x , y ] + {β}_{2} & if {Rec}_{L}^{′} [ x , y ] > Threshold\end{matrix} \qquad ( 8 )$$

### Slope Adjustment of CCLM

CCLM uses a model with 2 parameters to map luma values to chroma values. The slope parameter “a” and the bias parameter “b” define the mapping as follows:

$$chromaVal = a * lumaVal + b$$

An adjustment “u” to the slope parameter is signaled to update the model to the following form:

$$chromaVal = {a}^{′} * lumaVal + b$$

$$where {a}^{′} = a + u$$

$${b}^{′} = b - u * {y}_{r} .$$

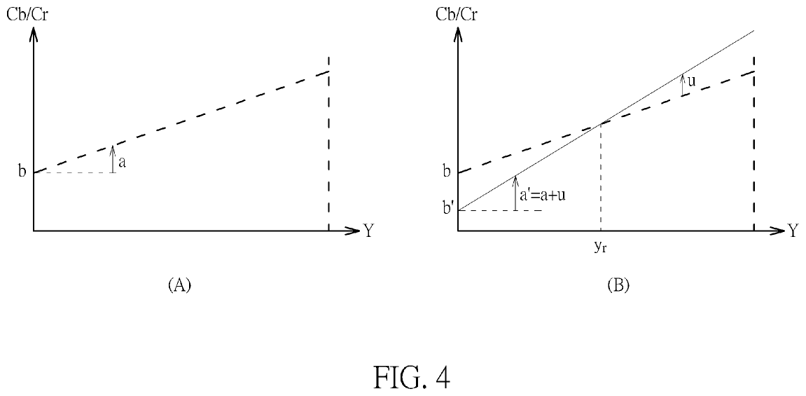

With this selection, the mapping function is tilted or rotated around the point with luminance value yᵣ. The average of the reference luma samples is used in the model creation as yᵣ in order to provide a meaningful modification to the model. FIG. 4 illustrates the process, where the sub-diagram (A) illustrates a model created with the current CCLM, and the sub-diagram (B) illustrated a model updated as proposed.

### Implementation

Slope adjustment parameter is provided as an integer between −4 and 4, inclusive, and signaled in the bitstream. The unit of the slope adjustment parameter is ⅛th of a chroma sample value per one luma sample value (for 10-bit content).

In one example, adjustment is available for the CCLM models that are using reference samples both above and left of the block (“LM_CHROMA_IDX” and “MMLM_CHROMA_IDX”), but not for the “single side” modes. This selection is based on coding efficiency vs. complexity trade-off considerations.

When slope adjustment is applied for a multi-mode CCLM model (or named as MMLM), both models can be adjusted and thus up to two slope updates are signaled for a single chroma block.

### Encoder Approach

The proposed encoder approach performs an SATD based search for the best value of the slope update for Cr and a similar SATD based search for Cb. If either one results as a non-zero slope adjustment parameter, the combined slope adjustment pair (SATD based update for Cr, SATD based update for Cb) is included in the list of RD checks for the TU.

### Convolutional Cross-Component Model (CCCM)

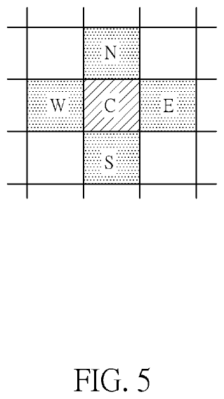

In CCCM, a convolutional model is applied to improve the chroma prediction performance. In one example, the convolutional model has 7-tap filter consist of a 5-tap plus sign shape spatial component, a nonlinear term and a bias term. The input to the spatial 5-tap component of the filter consists of a center (C) luma sample which is collocated with the chroma sample to be predicted and its above/north (N), below/south(S), left/west (W) and right/east (E) neighbors as illustrated in FIG. 5.

The nonlinear term (denoted as P) is represented as power of two of the center luma sample C and scaled to the sample value range of the content:

$$P = ( C * C + midVal ) ≫ bitDepth$$

That is, for 10-bit content it is calculated as:

$$P = ( C * C + 512 ) ≫ 10$$

The bias term (denoted as B) represents a scalar offset between the input and output (similarly to the offset term in CCLM) and is set to middle chroma value (512 for 10-bit content).

Output of the filter is calculated as a convolution between the filter coefficients ci and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B$$

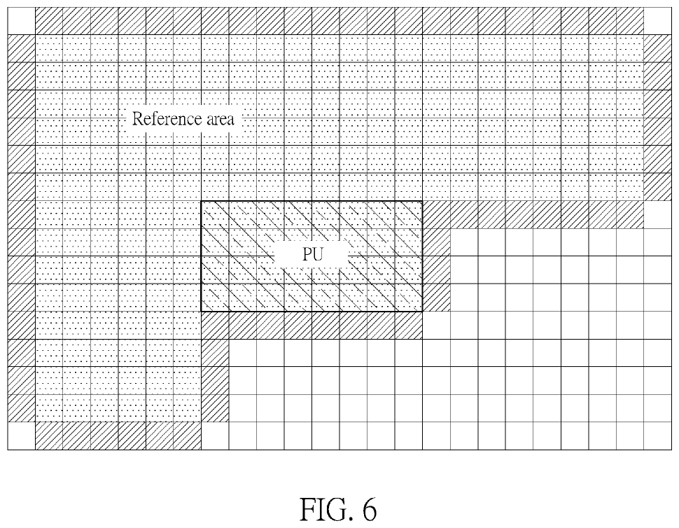

The filter coefficients ci are calculated by applying any pre-defined regression method or minimising MSE between predicted and reconstructed chroma samples in the reference area. FIG. 6 illustrates the reference area which consists of 6 lines of chroma samples above and left of the PU. Reference area extends one PU width to the right and one PU height below the PU boundaries. Area is adjusted to include only available samples. The extensions to the area shown in slash in the reference area are needed to support the “side samples” of the plus shaped spatial filter and are padded when in unavailable areas.

The MSE minimization or the pre-defined regression method is performed by calculating autocorrelation matrix for the luma input and a cross-correlation vector between the luma input and chroma output. In one example, autocorrelation matrix is LDL decomposed and the final filter coefficients are calculated using back-substitution. The process follows roughly the calculation of the ALF filter coefficients in Enhanced Compression Model (ECM), however LDL decomposition was chosen instead of Cholesky decomposition to avoid using square root operations. The autocorrelation matrix can be the mentioned method in this example and/or the regression method is not limited to the mentioned method in this example.

### Gradient Linear Model (GLM)

Compared with the CCLM, instead of down-sampled luma values, the GLM utilizes luma sample gradients to derive the linear model. Specifically, in one example, when the GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

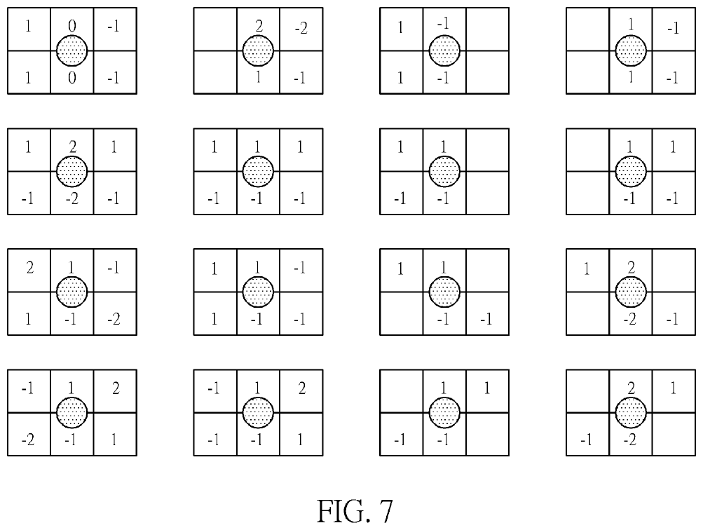

For signaling, when the CCLM mode is enabled to the current CU, two flags are signaled separately for Cb and Cr components to indicate whether GLM is enabled to each component; if the GLM is enabled for one component, one syntax element is further signaled to select one of 16 gradient filters for the gradient calculation, as illustrated in FIG. 7. The GLM can be combined with the existing CCLM by signaling one extra flag in bitstream. When such combination is applied, the filter coefficients that are used to derive the input luma samples of the linear model is calculated as the combination of the selected gradient filter of the GLM and the down-sampling filter of the CCLM.

### Intra Block Copy

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector is rounded to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 subblocks. For the current block of a larger size, a hash key is determined to match that of the reference block when all the hash keys of all 4×4 subblocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signaled as IBC AMVP mode or IBC skip/merge mode as follows:
IBC skip/merge mode: a merge candidate index is used to indicate which of the block vectors in the list from neighboring candidate IBC coded blocks is used to predict the current block. The merge list consists of spatial, HMVP, and/or pairwise candidates.
IBC AMVP mode: block vector difference is coded in the same way as a motion vector difference. The block vector prediction method uses two candidates as predictors, one from left neighbor and one from above neighbor (if IBC coded). When either neighbor is not available, a default block vector will be used as a predictor. A flag is signaled to indicate the block vector predictor index.

### IBC Reference Region

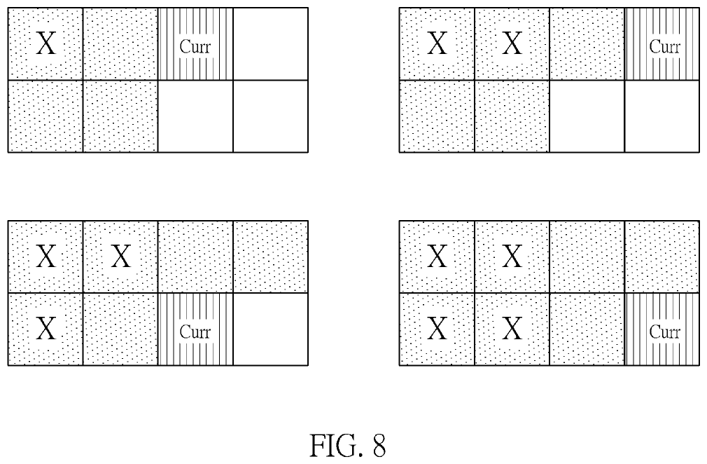

To reduce memory consumption and decoder complexity, the IBC in VVC allows only the reconstructed portion of the predefined area including the region of current CTU and some region of the left CTU. FIG. 8 illustrates the reference region of IBC Mode, where each block represents 64×64 luma sample unit.

Depending on the location of the current coded CU within the current CTU, the following applies:
If current block falls into the top-left 64×64 block of the current CTU, then in addition to the already reconstructed samples in the current CTU, it can also refer to the reference samples in the bottom-right 64×64 blocks of the left CTU, using current picture referencing (CPR) mode. (More details of CPR can be found in JVET-T2002.) The current block can also refer to the reference samples in the bottom-left 64×64 block of the left CTU and the reference samples in the top-right 64×64 block of the left CTU, using CPR mode.
If current block falls into the top-right 64×64 block of the current CTU, then in addition to the already reconstructed samples in the current CTU, if luma location (0, 64) relative to the current CTU has not yet been reconstructed, the current block can also refer to the reference samples in the bottom-left 64×64 block and bottom-right 64×64 block of the left CTU, using CPR mode; otherwise, the current block can also refer to reference samples in bottom-right 64×64 block of the left CTU.
If current block falls into the bottom-left 64×64 block of the current CTU, then in addition to the already reconstructed samples in the current CTU, if luma location (64, 0) relative to the current CTU has not yet been reconstructed, the current block can also refer to the reference samples in the top-right 64×64 block and bottom-right 64×64 block of the left CTU, using CPR mode. Otherwise, the current block can also refer to the reference samples in the bottom-right 64×64 block of the left CTU, using CPR mode.
If current block falls into the bottom-right 64×64 block of the current CTU, it can only refer to the already reconstructed samples in the current CTU, using CPR mode.
   This restriction allows the IBC mode to be implemented using local on-chip memory for hardware implementations.

### Chroma DM Mode

For Chroma DM mode, the intra prediction mode of the corresponding (collocated) luma block covering the center position of the current chroma block is directly inherited.

### Decoder Side Intra Mode Derivation (DIMD)

When DIMD is applied, two or more intra modes are derived from the reconstructed neighbor samples, and those two or more predictors are combined with the planar mode predictor with the weights derived from the gradients. The DIMD mode is used as an alternative prediction mode and is always checked in the high-complexity RDO mode.

To implicitly derive the intra prediction modes of a blocks, a texture gradient analysis is performed at encoder, decoder, or both sides. In one example, this process starts with an empty Histogram of Gradient (HoG) with 65 entries, corresponding to the 65 angular modes. In another example, this process may start with an empty HoG with a pre-defined number of entries, corresponding to the pre-defined number of angular modes where the pre-defined number can be any positive integer and/or 131 and/or any number larger than 65. Amplitudes of these entries are determined during the texture gradient analysis.

In the first step, DIMD picks a template of T=3 columns and lines from respectively left and above current block. This area is used as the reference for the gradient based intra prediction modes derivation.

In the second step, the horizontal and vertical Sobel filters are applied on all 3×3 window positions, centered on the pixels of the middle line of the template. On each window position, Sobel filters calculate the intensity of pure horizontal and vertical directions as Gₓ and G_{y}, respectively. Then, the texture angle of the window is calculated as:

$$angle = arctan ( {G}_{x} / {G}_{y} ) ,$$

which can be converted into one of 65 angular intra prediction modes in some examples. Once the intra prediction modes index of current window is derived as idx, the amplitude of its entry in the HoG[idx] is updated by addition of:

$$ampl = \vert {G}_{x} \vert + \vert {G}_{y} \vert$$

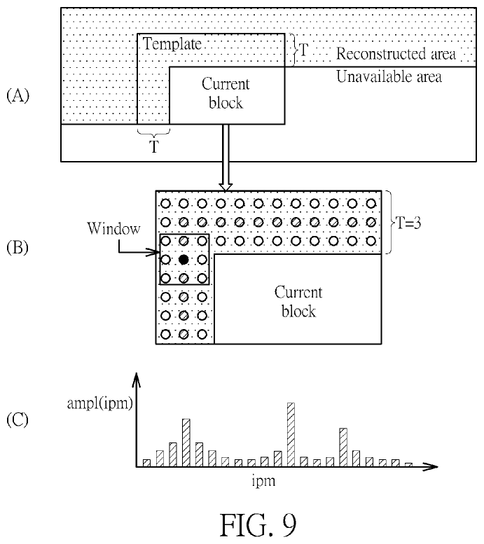

FIG. 9 shows an example of HoG, calculated after applying the above operations on all pixel positions in the template.

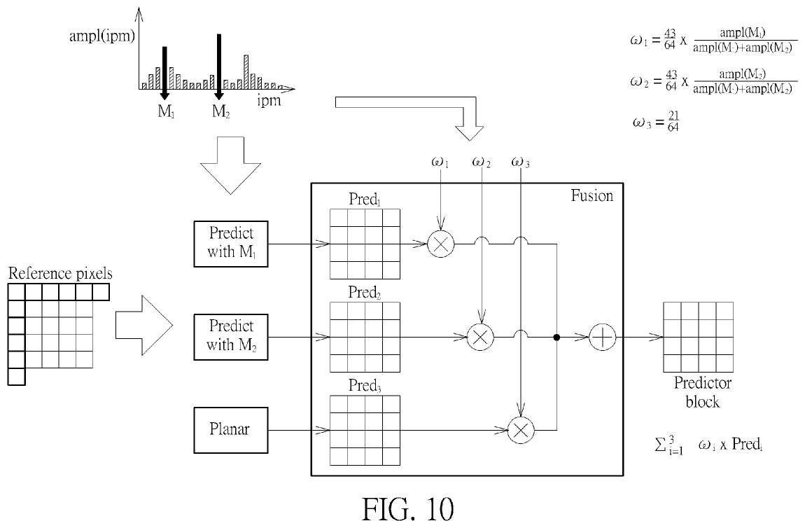

Once HoG is computed, the indices with two or more tallest histogram bars are selected as the two or more implicitly derived intra prediction modes for the block and are further combined with the Planar mode as the prediction of DIMD mode. The prediction fusion is applied as a weighted average of the above three or more predictors. To this aim, the weight of planar is fixed to 21/64 (~⅓). The remaining weight of 43/64 (~⅔) is then shared between the two or more HoG IPMs, proportionally to the amplitude of their HoG bars. FIG. 10 visualises this process and in this example, there are only 2 IPMs selected using HoG bars.

Besides, the two or more implicitly derived intra modes are included into the MPM list, so the DIMD process is performed before the MPM list is constructed. The primary derived intra mode of a DIMD block is stored with a block and is used for MPM list construction of the neighboring blocks.

### Template-Based Intra Mode Derivation (TIMD)

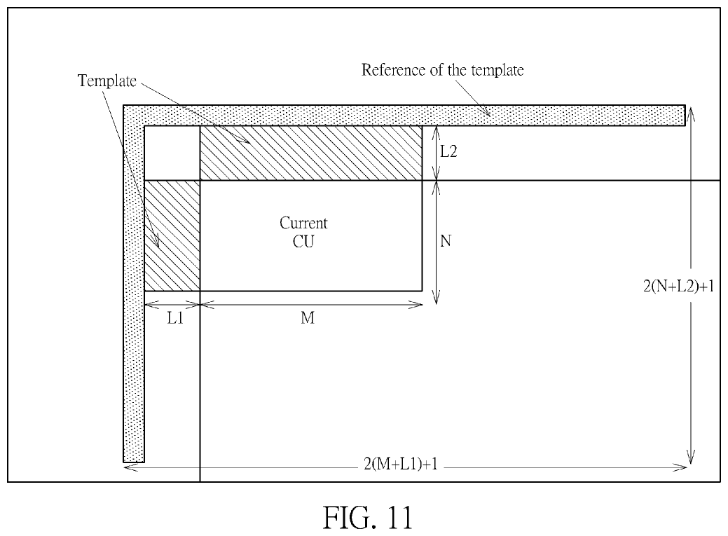

Template-based intra mode derivation (TIMD) mode implicitly derived the intra prediction mode of a CU by a neighboring template at encoder, decoder, or both, instead of being signal exact intra prediction mode bits to the decoder. As shown in FIG. 11, the prediction samples of the template are generated using the reference samples of the template for each candidate mode. A cost is calculated as the SATD between the prediction and the reconstruction samples of the template. The intra prediction mode with the minimum cost is selected as the TIMD mode and used for intra prediction of the CU. The candidate modes may be 67 intra prediction modes as in VVC or extended to 131 intra prediction modes. In general, MPMs can provide a clue to indicate the directional information of a CU. Thus, to reduce the intra mode search space and utilize the characteristics of a CU, the intra prediction mode is implicitly derived from MPM list.

For each intra prediction mode in MPMs, the SATD between the prediction and reconstruction samples of the template is calculated. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.

The costs of the two selected modes are compared with a threshold, in the test the cost factor of 2 is applied as follows:

$$costMode 2 < 2 * costMode 1.$$

If this condition is true, the fusion is applied, otherwise the only model is used. Weights of the modes are computed from their SATD costs as follows:

$$weight 1 = costMode 2 / ( c ostMode 1 + costMode 2 )$$

$$weight 2 = 1 - weight 1$$

### Inter Prediction Overview (More Details can be Found in JVET-T2002 Section 3.4.)

For each inter-predicted CU, motion parameters consisting of motion vectors, reference picture indices and/or reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and/or reference picture list usage flag and/or other needed information are signalled explicitly per each CU.

Beyond the inter coding features in HEVC, VVC includes a number of new and refined inter prediction coding tools listed as follows:
Extended merge prediction
Merge mode with MVD (MMVD)
Symmetric MVD (SMVD) signalling
Affine motion compensated prediction
Subblock-based temporal motion vector prediction (SbTMVP)
Adaptive motion vector resolution (AMVR)
Motion field storage: 1/16^{th} luma sample MV storage and 8×8 motion field compression
Bi-prediction with CU-level weight (BCW)
Bi-directional optical flow (BDOF)
Decoder side motion vector refinement (DMVR)
Geometric partitioning mode (GPM)
Combined inter and intra prediction (CIIP)

The following text provides the details on those inter prediction methods specified in VVC.

### Extended Merge Prediction

In VVC, the merge candidate list is constructed by including the following five types of candidates in order:
1) Spatial MVP from spatial neighbour CUs
2) Temporal MVP from collocated CUs
3) History-based MVP from an FIFO table
4) Pairwise average MVP
5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merge candidate lists (or called as merging candidate lists) for all CUs within a certain size of area.

### Spatial Candidates Derivation

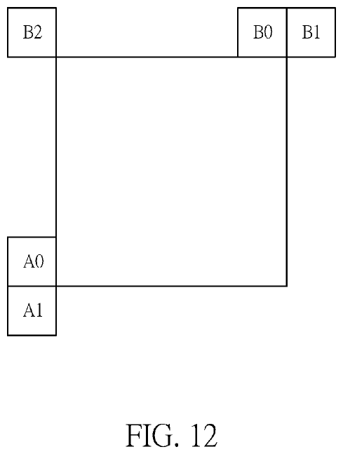

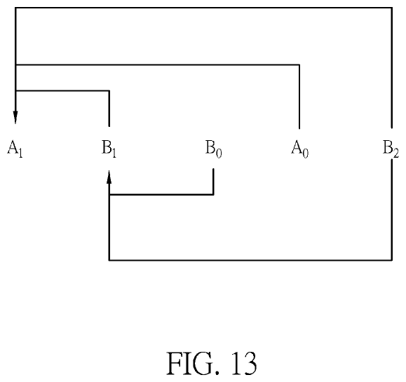

The derivation of spatial merge candidates in VVC is same to that in HEVC except the positions of first two merge candidates are swapped. A maximum of four merge candidates are selected among candidates located in the positions depicted in FIG. 12. The order of derivation is B₀, A₀, B₁, A₁ and B₂. Position B₂ is considered only when one or more than one CUs of position B₀, A₀, B₁, A₁ are not available (e.g. because it belongs to another slice or tile) or is intra coded. After the candidate at position A₁ is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. Instead only the pairs linked with an arrow in FIG. 13 are considered and a candidate is only added to the list if the corresponding candidate used for redundancy check has not the same motion information.

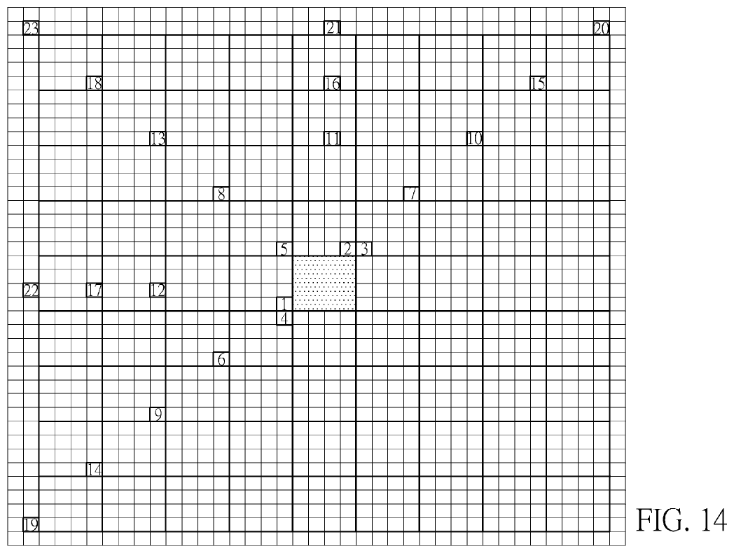

In addition to the above-mentioned spatial candidates, the non-adjacent spatial merge candidates as in JVET-L0399 are inserted after the TMVP in the regular merge candidate list. The pattern of spatial merge candidates is shown in FIG. 14. The distances between non-adjacent spatial candidates and current coding block are based on the width and/or height of current coding block. The line buffer restriction is not applied.

### Temporal Candidates Derivation

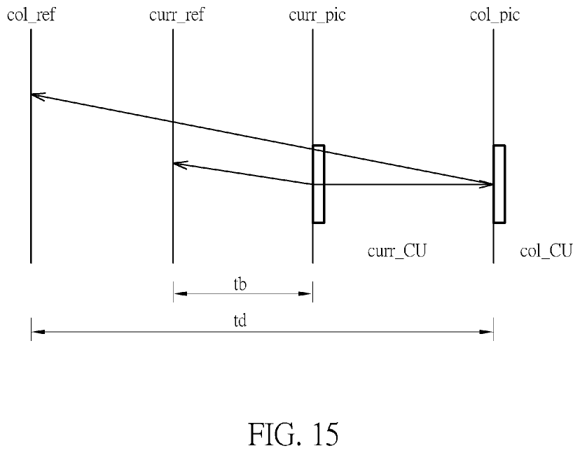

In this step, only one candidate is added to the list. Particularly, in the derivation of this temporal merge candidate, a scaled motion vector is derived based on co-located CU belonging to the collocated reference picture. The reference picture list and the reference index to be used for derivation of the co-located CU is explicitly signalled in the slice header. The scaled motion vector for temporal merge candidate is obtained as illustrated by the dotted line in FIG. 15, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

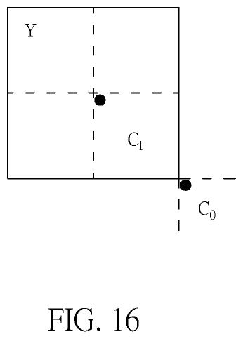

The position for the temporal candidate is selected between candidates C₀ and C₁, as depicted in FIG. 16. If CU at position C₀ is not available, is intra coded, or is outside of the current row of CTUs, position C₁ is used. Otherwise, position C₀ is used in the derivation of the temporal merge candidate.

### History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 5 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward, and the identical HMVP is inserted to the last entry of the table.

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications are introduced:
1. The last two entries in the table are redundancy checked to A₁ and B₁ spatial candidates, respectively.
2. Once the total number of available merge candidates reaches the maximally allowed merge candidates minus 1, the merge candidate list construction process from HMVP is terminated.

### Pair-Wise Average Merge Candidates Derivation

Pairwise average candidates are generated by averaging predefined pairs of candidates in the existing merge candidate list, using the first two merge candidates. The first merge candidate is defined as p0Cand and the second merge candidate can be defined as p1Cand, respectively. The averaged motion vectors are calculated according to the availability of the motion vector of p0Cand and p1Cand separately for each reference list. If both motion vectors are available in one list, these two motion vectors are averaged even when they point to different reference pictures, and its reference picture is set to the one of p0Cand; if only one motion vector is available, use the one directly; if no motion vector is available, keep this list invalid. Also, if the half-pel interpolation filter indices of p0Cand and p1Cand are different, it is set to 0.

When the merge list is not full after pair-wise average merge candidates are added, the zero MVPs are inserted in the end until the maximum merge candidate number is encountered.

### Merge Estimation Region

Merge estimation region (MER) allows independent derivation of merge candidate list for the CUs in the same merge estimation region (MER). A candidate block that is within the same MER to the current CU is not included for the generation of the merge candidate list of the current CU. In addition, the updating process for the history-based motion vector predictor candidate list is updated only if (xCb+cbWidth)>>Log 2ParMrgLevel is greater than xCb>>Log 2ParMrgLevel and (yCb+cbHeight)>>Log 2ParMrgLevel is great than (yCb>>Log 2ParMrgLevel) and where (xCb, yCb) is the top-left luma sample position of the current CU in the picture and (cb Width, cbHeight) is the CU size. The MER size is selected at encoder side and signalled as log 2_parallel_merge_level_minus2 in the sequence parameter set.

Bi-Prediction with CU-Level Weight (BCW)

In HEVC, the bi-prediction signal is generated by averaging two prediction signals obtained from two different reference pictures and/or using two different motion vectors. In VVC, the bi-prediction mode is extended beyond simple averaging to allow weighted averaging of the two prediction signals.

$${P}_{bi - pred} = ( ( 8 - w ) * {P}_{0} + w * {P}_{1} + 4 ) ≫ 3$$

Five weights are allowed in the weighted averaging bi-prediction, w∈{−2, 3, 4, 5, 10}. For each bi-predicted CU, the weight w is determined in one of two ways: 1) for a non-merge CU, the weight index is signalled after the motion vector difference; 2) for a merge CU, the weight index is inferred from neighbouring blocks based on the merge candidate index. BCW is only applied to CUs with 256 or more luma samples (i.e., CU width times CU height is greater than or equal to 256). For low-delay pictures, all 5 weights are used. For non-low-delay pictures, only 3 weights (w∈{3, 4, 5}) are used.
At the encoder, fast search algorithms are applied to find the weight index without significantly increasing the encoder complexity. These algorithms are summarized as follows. For further details readers are referred to the VTM software and document JVET-L0646. When combined with AMVR, unequal weights are only conditionally checked for 1-pel and 4-pel motion vector precisions if the current picture is a low-delay picture.
When combined with affine, affine ME will be performed for unequal weights if and only if the affine mode is selected as the current best mode.
When the two reference pictures in bi-prediction are the same, unequal weights are only conditionally checked.
Unequal weights are not searched when certain conditions are met, depending on the POC distance between current picture and its reference pictures, the coding QP, and the temporal level.

The BCW weight index is coded using one context coded bin followed by bypass coded bins. The first context coded bin indicates if equal weight is used; and if unequal weight is used, additional bins are signalled using bypass coding to indicate which unequal weight is used.

Weighted prediction (WP) is a coding tool supported by the H.264/AVC and HEVC standards to efficiently code video content with fading. Support for WP was also added into the VVC standard. WP allows weighting parameters (weight and offset) to be signalled for each reference picture in each of the reference picture lists L0 and L1. Then, during motion compensation, the weight(s) and offset(s) of the corresponding reference picture(s) are applied. WP and BCW are designed for different types of video content. In order to avoid interactions between WP and BCW, which will complicate VVC decoder design, if a CU uses WP, then the BCW weight index is not signalled, and w is inferred to be 4 (i.e. equal weight is applied). For a merge CU, the weight index is inferred from neighbouring blocks based on the merge candidate index. This can be applied to both normal merge mode and inherited affine merge mode. For constructed affine merge mode, the affine motion information is constructed based on the motion information of up to 3 blocks. The BCW index for a CU using the constructed affine merge mode is simply set equal to the BCW index of the first control point MV.

In VVC, CIIP and BCW cannot be jointly applied for a CU. When a CU is coded with CIIP mode, the BCW index of the current CU is set to 2, e.g. equal weight.

### Combined Inter and Intra Prediction (CIIP)

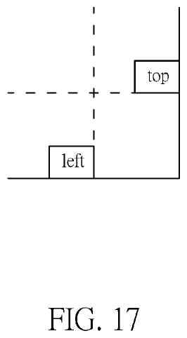

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pinter is derived using the same inter prediction process applied to regular merge mode; and the intra prediction signal Pᵢₙₜᵣₐ is derived following the regular intra prediction process with the planar mode or TIMD. Then, the intra and inter prediction signals are combined using weighted averaging, where the weight value is calculated depending on the coding modes of the top and left neighbouring blocks (depicted in FIG. 17) as follows:
If the top neighbor is available and intra coded, then set isIntraTop to 1, otherwise set isIntraTop to 0;
If the left neighbor is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.
   The CIIP prediction is formed as follows:

$${P}_{CIIP} = ( ( 4 - w t ) * {P}_{inter} + w t * {P}_{intra} + 2 ) ≫ 2$$

### Geometric Partitioning Mode (GPM)

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w×h=2^{m}×2ⁿ with m, n ∈{3 . . . 6} excluding 8×64 and 64×8.

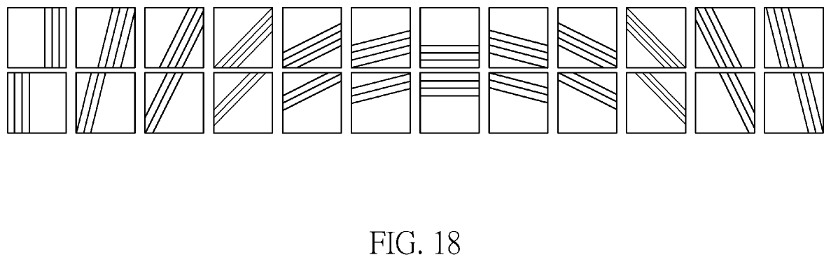

When this mode is used, a CU is split into two parts by a geometrically located straight line (FIG. 18). The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU. The uni-prediction motion for each partition is derived using the process described in the later section.

If geometric partitioning mode is used for the current CU, then a geometric partition index indicating the partition mode (partition line) of the geometric partition (angle and offset, or named angle and distance), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights as in the later section. This is the prediction signal for the whole CU, and transform and quantization process will be applied to the whole CU as in other prediction modes. Finally, the motion field of a CU predicted using the geometric partition modes is stored as in the later section.

### Uni-Prediction Candidate List Construction

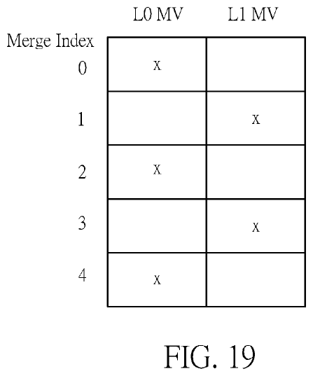

The uni-prediction candidate list is derived directly from the merge candidate list constructed according to the extended merge prediction process. Denote n as the index of the uni-prediction motion in the geometric uni-prediction candidate list. The LX motion vector of the n-th extended merge candidate, with X equal to the parity of n, is used as the n-th uni-prediction motion vector for geometric partitioning mode. These motion vectors are marked with “x” in FIG. 19. In case a corresponding LX motion vector of the n—the extended merge candidate does not exist, the L(1−X) motion vector of the same candidate is used instead as the uni-prediction motion vector for geometric partitioning mode.

### Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

In details, as JVET-Z0059, the weighted prediction, i.e., blending, is applied to the two prediction signals for each part of GPM derived by its own motion vector or its own intra prediction mode, in order to generate the final prediction samples around GPM partitioning boundary.

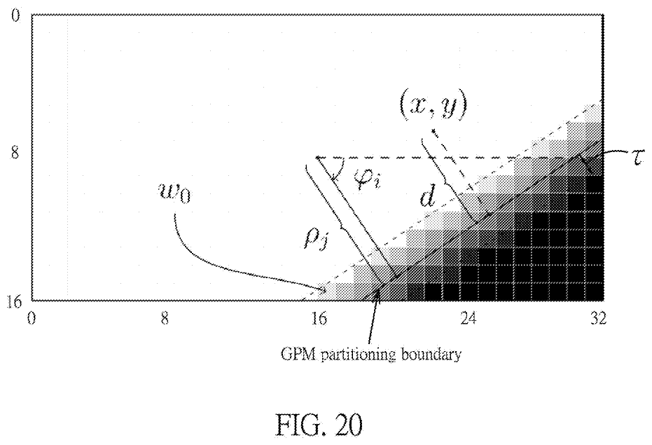

The two integer blending matrices (W₀ and W₁) are utilized for the GPM blending process. In one example, the weights in the GPM blending matrices contain the value range of [0, 8] and are derived based on the displacement from a sample position to the GPM partition boundary as shown in FIG. 20.

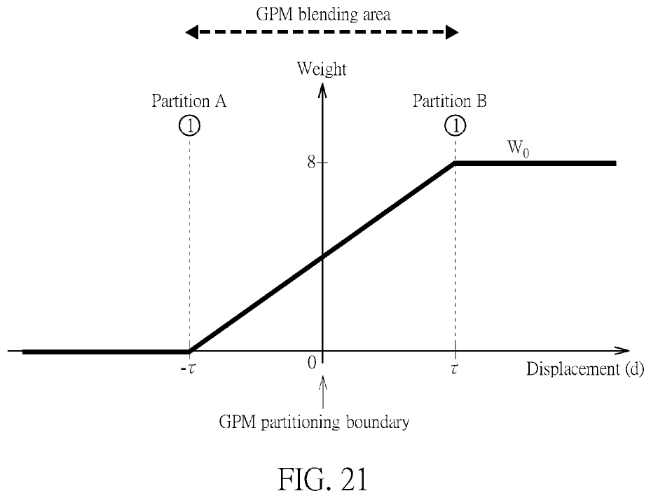

Specifically, the weights are given by a discrete ramp function with the displacement and two thresholds as shown in FIG. 21.

The ramp function for the weight of GPM derived based on the displacement from a sample position to the GPM partition boundary and the fixed threshold τ.

Here, the threshold τ defines the width of the GPM blending area and is selected as the fixed value in VVC.

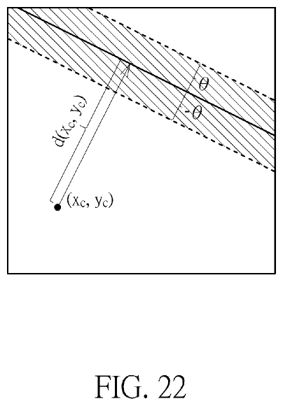

In other words, as JVET-Z0137, the blending strength or blending area width θ is fixed for all different contents as shown in FIG. 22.

The weighing values in the blending mask can be given by a ramp function

$${ω}_{{x}_{c} , {y}_{c}} = \{ \begin{matrix}0 & d ( {x}_{c} , {y}_{c} ) \leq - θ \\ \frac{8}{2 θ} ( d ( {x}_{c} {y}_{c} ) + θ ) & - θ < d ( {x}_{c} , {y}_{c} ) < θ \\ 8 & d ( {x}_{c} , {y}_{c} ) \geq θ ,\end{matrix}$$

With a fixed θ=2 pel in the current ECM (VVC) design, this ramp function can be quantized as

$${ω}_{m , n} = Clip 3 ( 0 , 8 , ( d ( m , n ) + 32 + 4 ) ≫ 3 )$$

Therefore, as JVET-T2002, the distance for a position (x, y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j}$$

$${ρ}_{j} = {ρ}_{x , j} cos ( {φ}_{i} ) + {ρ}_{y , j} sin ( {φ}_{i} )$$

$${ρ}_{x , j} = \{ \begin{matrix}0 & i \% 16 = 8 or ( i \% 16 \neq 0 and h \geq w ) \\ \pm ( j \times w ) ≫ 2 & otherwise\end{matrix}$$

$${ρ}_{y , j} = \{ \begin{matrix}\pm ( j \times h ) ≫ 2 & i \% 16 = 8 or ( i \% 16 \neq 0 and h \geq w ) \\ 0 & otherwise\end{matrix}$$

where i, j are the indices for angle and offset of a geometric partition, which depend on the signaled geometric partition index. The sign of ρ_{x,j} and ρ_{y,j} depend on angle index i.

The weights for each part of a geometric partition are derived as following:

$$wIdx L ( x , y ) = partIdx ? 32 + d ( x , y ) : 32 - d ( x , y )$$

$${w}_{0} ( x , y ) = \frac{Clip 3 ( 0 , 8 , ( wIdxL ( x , y ) + 4 ) ≫ 3 )}{8}$$

$${w}_{1} ( x , y ) = 1 - {w}_{0} ( x , y )$$

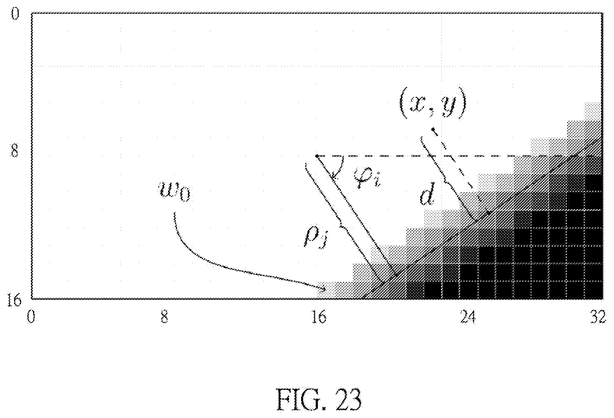

The partIdx depends on the angle index i. One example of weigh w₀ is illustrated in FIG. 23.

### Motion Field Storage for Geometric Partitioning Mode

Mv1 from the first part of the geometric partition, Mv2 from the second part of the geometric partition and a combined Mv of Mv1 and Mv2 are stored in the motion filed of a geometric partitioning mode coded CU.

The stored motion vector type for each individual position in the motion filed are determined as:

$$sType = abs ( motionIdx ) < 32 ? 2 : ( motionIdx \leq 0 ? ( 1 - partIdx ) : partIdx )$$

where motionIdx is equal to d(4x+2, 4y+2), which is recalculated. The partIdx depends on the angle index i.

If sType is equal to 0 or 1, Mv0 or Mv1 are stored in the corresponding motion field, otherwise if sType is equal to 2, a combined Mv from Mv0 and Mv2 are stored. The combined Mv are generated using the following process:
1) If Mv1 and Mv2 are from different reference picture lists (one from L0 and the other from L1), then Mv1 and Mv2 are simply combined to form the bi-prediction motion vectors.
2) Otherwise, if Mv1 and Mv2 are from the same list, only uni-prediction motion Mv2 is stored.
   GPM Extension (More details can be found in JVET-W0097 and JVET-Y0065.)

At the JVET-V meeting, several variations were proposed to improve the coding efficiency of the GPM mode in the VVC. The methods were included in the exploration experiment (EE2) for further evaluations, the main technical aspects of which are described as follows:

EE2-3.3 on GPM with MMVD (GPM-MMVD): 1) additional MVDs are added to the existing GPM merge candidates; 2) the MVDs are signaled in the same manner as the MMVD in the VVC, i.e., one distance index plus one direction index; 3) two flags are signaled to separately control whether the MMVD is applied to each GPM partition or not.

EE2-3.4-3.5 on GPM with template matching (GPM-TM): 1) template matching is extended to the GPM mode by refining the GPM MVs based on the left and above neighboring samples of the current CU; 2) the template samples are selected dependent on the GPM split direction; 3) one single flag is signaled to jointly control whether the template matching is applied to the MVs of two GPM partitions or not.

JVET-W0097 proposes a combination of EE2-3.3, EE2-3.4 and EE2-3.5 to further improve the coding efficiency of the GPM mode. Specifically, in the proposed combination, the existing designs in EE2-3.3, EE2-3.4 and EE2-3.5 are kept unchanged while the following modifications are further applied for the harmonization of the two coding tools:

1) The GPM-MMVD and GPM-TM are exclusively enabled to one GPM CU. This is done by firstly signaling the GPM-MMVD syntax. When both two GPM-MMVD control flags are equal to false (i.e., the GPM-MMVD are disabled for two GPM partitions), the GPM-TM flag is signaled to indicate whether the template matching is applied to the two GPM partitions. Otherwise (at least one GPM-MMVD flag is equal to true), the value of the GPM-TM flag is inferred to be false.

2) The GPM merge candidate list generation methods in EE2-3.3 and EE2-3.4-3.5 are directly combined in a manner that the MV pruning scheme in EE2-3.4-3.5 (where the MV pruning threshold is adapted based on the current CU size) is applied to replace the default MV pruning scheme applied in EE2-3.3; additionally, as in EE2-3.4-3.5, multiple zero MVs are added until the GPM candidate list is fully filled.

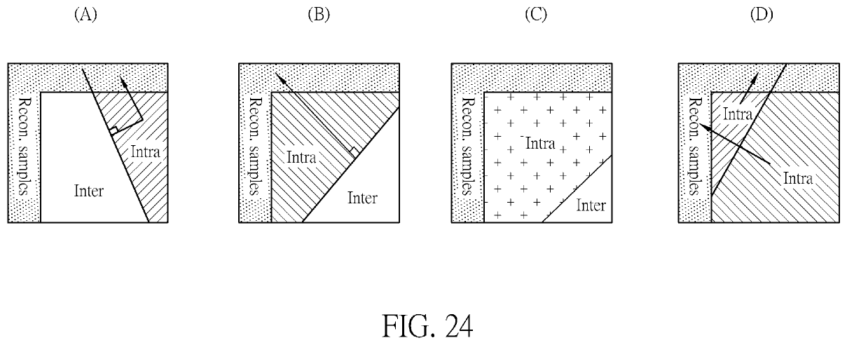

In JVET-Y0065, in GPM with inter and intra prediction (or named GPM intra), the final prediction samples are generated by weighting inter predicted samples and intra predicted samples for each GPM-separated region. The inter predicted samples are derived by the same scheme as the GPM in the current ECM whereas the intra predicted samples are derived by an intra prediction mode (IPM) candidate list and an index signaled from the encoder. The IPM candidate list size is pre-defined as 3. The available IPM candidates are the parallel angular mode against the GPM block boundary (Parallel mode), the perpendicular angular mode against the GPM block boundary (Perpendicular mode), and the Planar mode as shown in sub-diagrams (A)-(C) of FIG. 24, respectively. Furthermore, GPM with intra and intra prediction as shown in sub-diagram (D) of FIG. 24 is restricted in the proposed method to reduce the signalling overhead for IPMs and avoid an increase in the size of the intra prediction circuit on the hardware decoder. In addition, a direct motion vector and IPM storage on the GPM-blending area is introduced to further improve the coding performance.

### Spatial GPM (More Details can be Found in JVET-Z0124.)

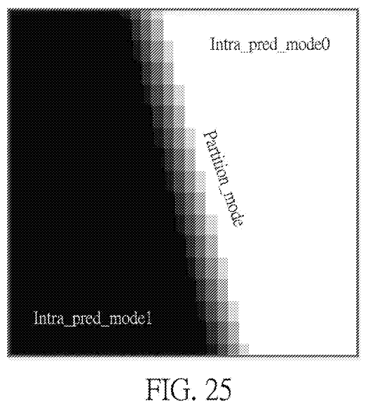

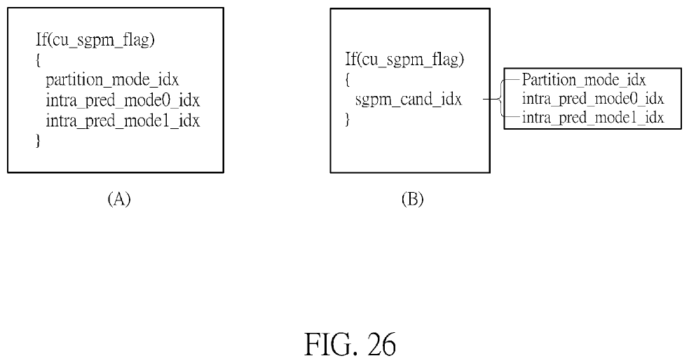

Similar to inter GPM, Spatial GPM (SGPM) consists of one partition mode and two associated intra prediction modes, as illustrated in FIG. 25. If these modes are directly signaled in the bit-stream, as shown in sub-diagram (A) of FIG. 26, it would yield significant overhead bits. To express the necessary partition and prediction information more efficiently in the bit-stream, a candidate list is employed and only the candidate index is signaled in the bit-stream. Each candidate in the list can derive a combination of one partition mode and two intra prediction modes, as shown in sub-diagram (B) of FIG. 26.

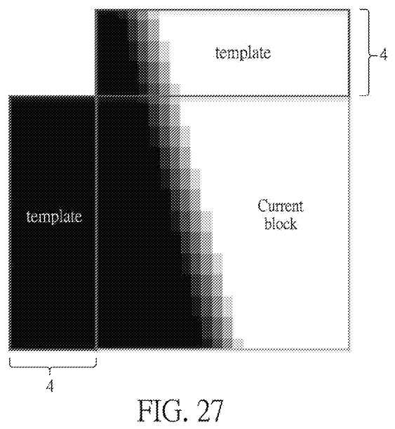

A template is used to generate this candidate list. The shape of the template is shown in FIG. 27. For each possible combination of one partition mode and two intra prediction modes, a prediction is generated for the template with the partitioning weight extended to the template, as shown in FIG. 27. These combinations are ranked in ascending order of their SATD between the prediction and reconstruction of the template. The length of the candidate list is set equal to 16, and these candidates are regarded as the most probable SGPM combinations of the current block. Both encoder and decoder construct the same candidate list based upon the template.

To reduce the complexity in building the candidate list, both the number of possible partition modes and the number of possible intra prediction modes are pruned. In the following test, 26 out of 64 partition modes are used, and only the MPMs out of 67 intra prediction modes are used.

### OBMC (More Details can be Found in JVET-W2025.)

When OBMC is applied, top and left boundary pixels of a CU are refined using neighboring block's motion information with a weighted prediction as described in JVET-L0101.

Conditions of not applying OBMC are as follows:
When OBMC is disabled at SPS level
When current block has intra mode or IBC mode
When current block applies LIC
When current luma block area is smaller or equal to 32

A subblock-boundary OBMC is performed by applying the same blending to the top, left, bottom, and right subblock boundary pixels using neighboring subblocks' motion information. It is enabled for the subblock based coding tools:
Affine AMVP modes;
Affine merge modes and subblock-based temporal motion vector prediction (SbTMVP);
Subblock-based bilateral matching.

### Proposed Invention

In addition to the introduced cross-component modes, for example, CCLM and/or MMLM and/or CCCM and/or slope adjustment of CCLM and/or GLM, several novel cross-component modes are proposed in some embodiments. For example, inverse LM and/or prediction-based LM. In this invention, one or more cross-component modes are used to generate cross-component prediction and the cross-component prediction is used to form the prediction for the current block which is coded with a non-intra mode. For example, the non-intra mode refers to any inter mode or any IBC mode. In one embodiment, the prediction of the current block, which is coded with the non-intra mode, is generated using one or more inter prediction modes, one or more cross-component modes, or both if the non-intra mode refers to an inter mode. The prediction of the current block, which is coded with the non-intra mode, is generated using one or more IBC prediction modes, one or more cross-component modes, or both if the non-intra mode refers to an IBC mode. The cross-component modes in this invention can refer to any one or more mentioned cross-component modes and/or the cross-component modes in this invention are not limited to the mentioned cross-component modes. In one embodiment, the one or more cross-component modes are selected from a merge candidate list. In another embodiment, the cross-component prediction is generated using multiple cross-component modes. For example, the cross-component prediction is generated using MH CCLM. In some embodiment, in addition to forming the prediction for the current block which is coded with a non-intra mode, in some cases, the cross-component modes can be used to improve intra prediction. For example, Adaptive Intra-mode Selection. For another example, LM assisted Angular/Planar Mode.

### Inverse LM

For the CCLM mode, luma reconstructed samples are used to derive the predictors in the chroma block. In this disclosure, inverse LM is proposed to use chroma information to derive the predictors in the luma block. When supporting inverse LM, chroma are encoded/decoded (signalled/parsed) before luma.

In one embodiment, the chroma information refers to the chroma reconstructed samples. When deriving model parameters for inverse LM, reconstructed neighbouring chroma samples are used as X as neighbouring luma samples for model derivation in traditional CCLM and reconstructed neighbouring luma samples are used as Y as neighbouring chroma samples for model derivation in traditional CCLM. Moreover, the reconstructed samples in the chroma block (collocated to the current luma block) and the derived parameters are used to generate the predictors in the current luma block. An alternative way is that “information” in this embodiment can refer to predicted samples.

In one embodiment, chroma refers to cb and/or cr component(s).

In one sub-embodiment, only one of cb's and er's information is used.

In another sub-embodiment, the chroma information is from both cb and cr. For example, the neighbouring reconstructed cb and cr samples are weighted and then used as the inputs of deriving model parameters. In another example, the reconstructed cb and cr samples in the chroma block (collocated with the current luma block) are weighted and then used to derive the predictors in the current luma block.

In another embodiment, for the current luma block, the prediction (generated by the proposed inverse LM) can be combined with one or more hypotheses of predictions (generated by one or more other intra prediction modes).

In one sub-embodiment, “other intra prediction modes” can refer to angular intra prediction modes, DC, planar, MIP, ISP, MRL, any other existing intra modes (supported in HEVC/VVC) and/or any other intra prediction modes.

In another sub-embodiment, when combining multiple hypotheses of predictions, weighting for each hypothesis can be fixed or adaptively changed. For example, equal weights are applied to each hypothesis. In another example, weights vary with neighbouring coding information, sample position, block width, height, prediction mode or area. Some examples of neighbouring coding information usage are shown as follows:
One possible rule related to sample position is described as follows.
   When the sample position is further away from the reference samples, the weight for the prediction from other intra prediction modes decreases.
Another possible rule related to neighbouring coding information is described as follows.
   When more neighbouring blocks (left, above, left-above, right-above, and/or left-bottom) are coded with a particular (e.g. Mode A), the weight for the prediction from Mode A gets higher.
Another possible rule related to sample position is described as follows.
   The current block is partitioned into several regions. The sample positions in the same region share the same weighting. If the current region is close to the reference L neighbour, the weight for prediction from other intra prediction modes is higher than the weight for prediction from CCLM. The following shows some possible ways to partition the current block.
(ratio of width and height close to or exactly 1:1): The distance between the current region and the left and top reference L neighbour is considered.
(width>n*height, where n can be any positive integer): The distance between the current region and the one of the top and left reference L neighbour is considered. For example, the distance between the current region and the left reference L neighbour is considered.
(height>n*width, where n can be any positive integer): The distance between the current region and one of the top and left reference L neighbour is considered. For example, the distance between the current region and the top reference L neighbour is considered.

### Prediction-Based LM

A novel LM method is proposed in this section. Different from the CCLM, the derived model parameters are applied to the predicted samples for the first component to get the predicted samples for the second or third component.

$$P ( i , j ) = a \cdot {pred}_{L}^{′} ( i , j ) + b$$

In one embodiment, the first component is luma.

In one sub-embodiment, the predicted samples for the first component are down-sampling with the downsampling filters. For example, the downsampling filters follow the original LM design. For another example, the downsampling filters will not access neighboring predicted/reconstructed samples. At the boundary of the current block, if the neighboring samples are required to be the input samples of downsampling filters, padded predicted values from the boundary of current block is used instead.

In another embodiment, the second component is Cb.

In another embodiment, the third component is Cr.

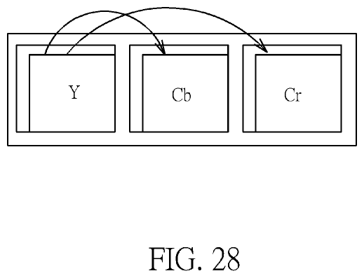

The following shows a flow of prediction-based inter CCLM, which means using cross-component prediction to form the inter chroma prediction.
Improve inter chroma prediction by linearly predicting chroma samples from luma samples as illustrated in FIG. 28
The linear predicting method can be one of
   CCLM_LT, CCLM_L, CCLM_T
   MMLM_LT, MMLM_L, MMLM_T, and/or any cross-component modes.
Steps:
   Step 1: Derive the linear model by neighboring luma and chroma reconstructed samples
   Step 2: Apply the derived linear model to current luma predicted samples to get current chroma predicted samples

$$pre {d}_{CCLM} ( i , j ) = α \cdot {pred}_{L}^{′} ( i , j ) + β$$

pred_{L}′(i,j): down-sampled current luma predicted samples
   At the boundary inside the current block, padding is used. For example, when the down-sampling process references any samples outside of the current luma predicted samples of the luma block, padding is used.

### Multiple-Hypothesis of CCLM Prediction (MH CCLM)

In addition to CCLM (for cb, deriving model parameters from luma and cb; for cr, deriving model parameters from luma and cr), more CCLM variations appear. The following shows some examples.
One variation is for cr:
   Deriving model parameters by using neighboring reconstructed samples of cb and cr as the inputs X as neighbouring luma samples for model derivation in traditional CCLM and Y as neighbouring chroma samples for model derivation in traditional CCLM of model derivation
   Then generating cr prediction by the derived model parameters and cb reconstructed samples.
Another variation is MMLM.
Another variation is that for cb (or cr), deriving model parameters from multiple collocated luma blocks.

Each cross-component mode, for example, each CCLM method, is suitable for different scenarios. For some complex feature, the combined prediction may bring better performance. Therefore, multiple-hypothesis CCLM is proposed to blend the predictions from multiple CCLM methods. The to-be-blended CCLM methods can be from (but are not limited to) the above mentioned CCLM methods and/or (*) which is shown as follows. (*) The one or more LM mode(s) (or cross-component mode(s)) which will be used to generate the one or more hypotheses of predictions for LM assisted Angular/Planar Mode and/or inter CCLM and/or MH CCLM are selected from a pre-defined merging candidate list (called modelList). One modelIdx is signalled to select a candidate from the candidate list (modelList) and the selected candidate is used for the current block. The modelList contains one or more candidates where each candidate refers to a model (or cross-component mode) information. If only one candidate is in the list (the size of the list is only 1), the modelIdx is not signalled and/or can be inferred as 0 or a default value.

A weighting scheme is used for blending.

In one embodiment, the weights for predictions from different to-be-blended CCLM methods are pre-defined at encoder and/or decoder.

In another embodiment, the weights for predictions from different to-be-blended CCLM methods vary based on the distance between the sample (or region) positions and the reference sample positions.

In another embodiment, the weights for predictions from different to-be-blended CCLM methods depend on the neighboring coding information.

In another embodiment, the weights for predictions from different to-be-blended CCLM methods depend on signalling. For example, a weight index is signaled/parsed. The code words can be fixed or vary adaptively. For example, the code words vary with template-based methods. The template refers to the spatial neighboring region of the current block.

The above embodiments can be combined. For example, the weights for predictions from different to-be-blended CCLM methods are pre-defined at encoder and/or decoder. The pre-defined weights vary with template-based methods. The template refers to the spatial neighboring region of the current block.

### Adaptive Intra-Mode Selection

With improvement of video coding, more coding tools are created. The syntax overhead of selecting a coding tool becomes an issue. Several straightforward methods can be used to reduce the syntax overhead.
Example 1: A large block uses the same coding mode.
Example 2: Multiple components (e.g. cb and cr) share the same coding mode.

However, with these straightforward methods, the accuracy/performance for intra prediction decreases. The possible reasons may be following:
Intra prediction is highly related to neighboring reference samples. When the whole block uses a single intra prediction mode, the intra prediction mode may be suitable for those samples which are close to the reference samples but may not be good for those samples which are far away from the reference samples.
when doing cr, the reconstructions of cb and luma were generated and can be used to choose the coding mode for cr.

In this section, it is proposed to adaptively change the intra prediction mode for one or more sample(s) or subblock(s) within the current block according to previous coding/decoding of components.

In one embodiment, with the reconstruction of the previously encoded/decoded components, the performance for the different coding modes is decided. Then, the better mode is used for the rest component(s) (subsequently encoded and decoded component(s)). For example, for cb, the prediction from traditional intra prediction modes (e.g. angular intra prediction modes, DC, planar) is better than the prediction from LM mode. (E.g. “better” means similar to cb's reconstruction.) Then, the traditional intra prediction mode is preferable for cr.

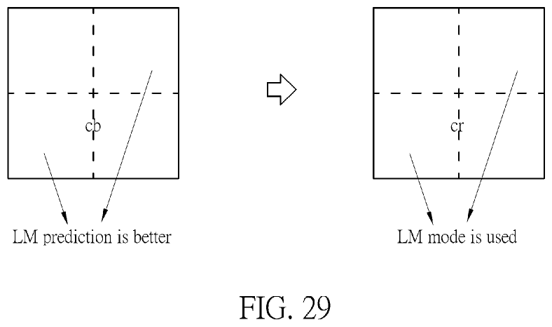

In one sub-embodiment, the proposed method can be subblock based. For example, a chroma block is divided into several sub-blocks. For each subblock, if for cb, the subblock's prediction from LM mode is better than the subblock's prediction from traditional intra prediction modes (e.g. angular intra prediction modes, DC, planar). (e.g. “better” means similar to cb's reconstruction and reducing the cb's residual), then the LM mode is preferable for the corresponding subblock of cr. (An example is shown in the FIG. 29)

In another embodiment, the adaptive changing rule can be performed at both encoder and/or decoder and doesn't need additional syntax.

CCLM for Inter Block (CCLM for inter block can also be named as inter CCLM and “CCLM” can be extended to any LM mode (or any cross-component mode, for example, (*)) or replaced with any LM mode (or any cross-component mode, for example, (*))))

CCLM is used for intra blocks to improve chroma intra prediction. For an inter block, chroma prediction may be not as accurate as luma. Possible reasons are listed below:
Motion vectors for chroma components are inherited from luma, (Chroma doesn't have its own motion vectors.)
Less coding tools are designed to improve inter chroma prediction.

Therefore, an alternative way to apply CCLM to inter blocks is proposed. With this proposed method, chroma prediction for inter block can be improved according to luma. (*) is shown as follows. (*) The one or more LM mode(s) (or cross-component mode(s)) which will be used to generate the one or more hypotheses of predictions for LM assisted Angular/Planar Mode and/or inter CCLM and/or MH CCLM are selected from a pre-defined merging candidate list (called modelList). One modelIdx is signalled to select a candidate from the candidate list (modelList) and the selected candidate is used for the current block. The modelList contains one or more candidates where each candidate refers to a model (or cross-component mode) information. If only one candidate is in the list (the size of the list is only 1), the modellIdx is not signalled and/or can be inferred as 0 or a default value.

In one embodiment, for chroma components, in addition to original inter prediction (generated by motion compensation which can be uni-prediction and/or bi-prediction, or which can be only uni-prediction), one or more hypotheses of predictions (generated by CCLM and/or any other LM modes and/or or any cross-component mode and/or (*)) are used to form the current prediction.

In one sub-embodiment, the current prediction is the weighted sum of inter prediction and cross-component prediction, for example, CCLM prediction. Weights are designed according to neighboring coding information, sample position, block width, height, mode or area.
For example, for a small block (area<threshold), weights for CCLM prediction are higher than weights for inter prediction.
For another example, when most neighboring coded blocks are intra blocks, weights for CCLM prediction are higher than weights for inter prediction.
For another example, weights are fixed values for the whole block.

In another embodiment, the inter prediction can be generated by any inter mode mentioned in the above introduction/documents. For example, the inter mode can be regular merge mode. For another example, the inter mode can be CIIP mode. For another example, the inter mode can be CIIP PDPC. For another example, the inter mode can be GPM or any GPM variations (like GPM intra).

In one sub-embodiment, regular merge mode is a merge candidate selected from the merge candidate list with a signalled merge index.

In another sub-embodiment, regular merge mode can be MMVD.

In another sub-embodiment, the LM mode used in inter CCLM is prediction-based LM.

In another embodiment, inter CCLM is supported only when any one (or more than one) of the pre-defined inter mode is used for the current block, or inter CCLM is supported when any one (or more than one) of the enabling flag(s) of the pre-defined inter mode is (are) indicated as enabled. The meaning of supporting inter CCLM is that the prediction of the current block can be chosen between applying inter CCLM or not applying inter CCLM.

When applying inter CCLM, the prediction of current block is generated by
In one sub-embodiment: blending one or more hypotheses of predictions (generated by CCLM and/or any other LM modes and/or any cross-component modes) with original inter prediction
   Blending the chroma prediction for existing inter mode and the prediction from LM
   Blending: Predfinal=(wInter*PredInter+wLM*PredLM+2)>>2
   Weighting rule: wInter and wLM, for example
      If both top and left are intra, (wInter, wLM)=(1, 3)
      Otherwise, if one of top and left is intra, (wInter, wLM)=(2, 2)
      Otherwise, (wInter, wLM)=(3, 1)
      For another example, the weighting follows CIIP weighting.
   For example, PredInter=inter prediction after OBMC (if OBMC is used)
   For another example, PredInter=inter prediction before OBMC (OBMC can be applied after blending)
In another sub-embodiment: replacing original inter prediction with one or more hypotheses of predictions (generated by CCLM and/or any other LM modes and/or any cross-component modes)

When not applying inter CCLM, the prediction of current block is from original inter prediction.

In another embodiment, the choice between applying inter CCLM or not applying inter CCLM depends on signaling.

In one sub-embodiment, a flag is signalled in the bitstream to indicate whether to apply inter CCLM or not. For example, the flag is context coded. For another example, only one context is used to encode and/or decode the flag. For another example, multiple contexts are used to encode and/or decode the flag and the selection of the contexts depends on block width, block height, block area, or neighboring mode information.

In another sub-embodiment, when the signaling indicates to apply inter CCLM, additional signaling is used to select one or more than one LM from total candidate LM modes (e.g. CCLM_LT, CCLM_L, CCLM_T, MMLM_L, MMLM_T, MMLM_L, or any subset/extension from the above mentioned modes). For example, if one LM mode is selected, the LM prediction is generated by the selected one LM. For another example, if more than one LM modes are selected the LM prediction is generated by blending hypotheses of predictions from multiple LM modes. For another example, the additional signaling refers to an index in the bitstream which can be truncated unary coding with and/or without contexts.

In another sub-embodiment, when the signaling indicates to apply inter CCLM, one or more than one LM from total candidate LM modes (e.g. CCLM_LT, CCLM_L, CCLM_T, MMLM_L, MMLM_T, MMLM_L, or any subset/extension from the above mentioned modes) is (are) implicitly selected (or predefined) to be used in inter CCLM.
For example, when (*) is used to generate the cross-component prediction, one candidate is selected from the modellIdx implicitly.
For example, CCLM_LT is used to generate LM prediction for inter CCLM. For example, MMLM_LT is used to generate LM prediction for inter CCLM.
For another example, the predefined rule depends on block width, block height, or block area.
   Boundary matching setting (used as the predefined rule) can be applied only when the block width, block height, or block area is larger than a threshold.
   Boundary matching setting (used as the predefined rule) can be applied only when the block width, block height, or block area is smaller than a threshold.
   When the block width, block height, or block area is smaller than a threshold, the selected LM mode(s) is (are) inferred as any one (more than one) LM mode(s) from total candidate LM modes.
      The selected LM mode is fixed as CCLM_LT.
      The selected LM mode is fixed as MMLM_LT.
For another example, the predefined rule depends on boundary matching setting. (Details of boundary matching setting can be found in the section of boundary matching setting. The candidate mode used in the section of boundary matching setting refers to each candidate LM mode for inter CCLM. The prediction from a candidate mode used in the section of boundary matching setting refers to the prediction generated by each candidate LM mode or refers to the blended prediction from each candidate LM mode and original inter.)

In another embodiment, inter CCLM can be supported only when the size conditions of the current block are satisfied.

In one sub-embodiment, the size condition is that the block width, block height, and/or block area is larger than a pre-defined threshold. The predefine threshold can a positive integer like 8, 16, 32, 64, 128, 256, . . . . For example, when both the block width and block height of the current chroma block are larger than the pre-defined threshold, the size condition is satisfied. For example, when any one of the block width and block height of the current chroma block is larger than the pre-defined threshold, the size condition is satisfied.

In another sub-embodiment, the size condition is that the block width, block height, or block area is smaller than a pre-defined threshold. The predefine threshold can a positive integer like 8, 16, 32, 64, 128, 256, 512, 1024, 2048, 4096 . . . . For example, when both the block width and block height of the current chroma block are smaller than the pre-defined threshold, the size condition is satisfied.

In another embodiment, the inter mode used in the inter block depends on an enabling flag. For example, if the inter mode is regular merge, the enabling flag is called as regular merge flag. For another example, if the inter mode is CIIP, the enabling flag is called as CIIP flag. For another example, if the inter mode is CIIP PDPC, the enabling flag is called as CIIP PDPC Flag. For another example, the enabling flag indicated as enabled (1) means the corresponding inter mode is applied to the current block. For another example, the enabling flag indicated as disabled (0) means the corresponding inter mode is not applied to the current block. For another example, the enabling flag is signalled in the bitstream and/or inferred in some cases. For another example, the signaling of the enabling flag depends on block width, block height, or block area.

In another embodiment, the prediction from inter can be adjusted by the neighboring reconstructed samples and a pre-defined weighting scheme. For example, when the current block is merge, the prediction from merge is blended with the neighboring reconstructed samples. For another example, the proposed scheme is enabled depending on CIIP PDPC flag. (The CHIP PDPC flag may be signalled when the CHIP flag is indicated as enabled.) For another example, the pre-defined weighting scheme follows PDPC weighting.

### (Details can be Found in the Following)

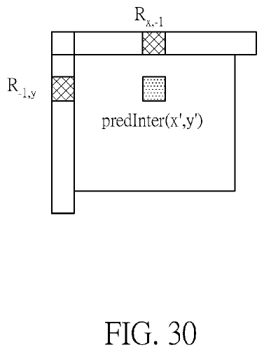

Inter-predictor of regular merge mode is refined using the above R_{x, -1} and left R_{-1,y} reconstructed samples as illustrated in FIG. 30
Derivation of nScale and wT & wL are the same as in intra planar mode

$$wT = 32 ≫ ( ( {y}^{′} ≪ 1 ) ≫ nScale )$$

$$wL = 32 ≫ ( ( {x}^{′} ≪ 1 ) ≫ nScale )$$

$$nScale = ( floorLog 2 ( width ) + floorLog 2 ( height ) - 2 ) ≫ 2 ;$$

CHIP PDPC:
   If LMCS is enabled, inter-predictor is computed in mapped domain

$$Pred ( x , y ) = ( ( ( ( wT \times {R}_{x , - 1} + wL \times {R}_{- 1 , y} + 32 ) ≫ 6 ) ≪ 6 ) + ( 64 - wT - wL ) \times Fwd ( predInter ( x , y ) + 32 ) ≫ 6$$

Otherwise, inter-predictor is computed in original domain

$$Pred ( x , y ) = ( ( ( ( wT \times {R}_{x , - 1} + wL \times {R}_{- 1 , y} + 32 ) ≫ 6 ) ≪ 6 ) + ( 64 - wT - wL ) \times predInter ( x , y ) + 32 ) ≫ 6$$

When CIIP flag is true, CIIP PDPC flag is further signaled to indicate whether to use CIIP PDPC

In another embodiment, original inter prediction (generated by motion compensation) is used for luma and the predictions of chroma components are generated by CCLM and/or any other LM modes.

In one sub-embodiment, the current CU is viewed as an inter CU, intra CU, or a new type of prediction mode (neither intra nor inter).

The above proposed methods can be also applied to IBC blocks. (“inter” in this section can be changed to IBC.) That is, for chroma components, the block vector prediction can be combined or replaced with CCLM (or any cross-component mode) prediction.

### Boundary-Matching Setting

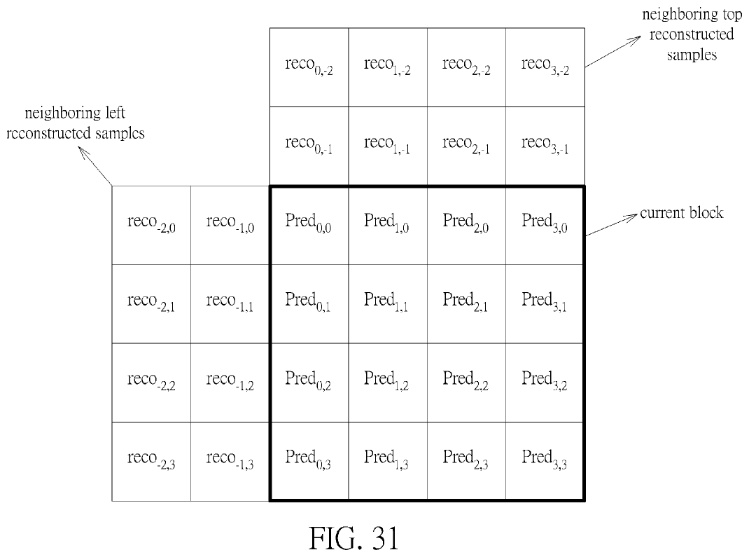

When boundary-matching setting is used, a boundary matching cost for a candidate mode refers to the discontinuity measurement (including top boundary matching and/or left boundary matching) between the current prediction (the predicted samples within the current block), generated from the candidate mode, and the neighboring reconstruction (the reconstructed samples within one or more neighboring blocks), as illustrated in FIG. 31. Top boundary matching means the comparison between the current top predicted samples and the neighboring top reconstructed samples, and left boundary matching means the comparison between the current left predicted samples and the neighboring left reconstructed samples.

In one embodiment, the candidate mode with the smallest boundary matching cost is applied to the current block.

In another embodiment, the boundary matching cost for Cb and Cr can be added to be the boundary matching cost for chroma, so the selected candidate mode for Cb and Cr will be shared. (That is the selected candidate mode for Cb and Cr will be the same.)

In another embodiment, the selected candidate modes for Cb and Cr depend on the boundary matching costs for Cb and Cr, respectively, so the selected candidate modes for Cb and Cr can be the same or different.

In another embodiment, a pre-defined subset of the current prediction is used to calculate the boundary matching cost. n line(s) of top boundary within the current block and/or m line(s) of left boundary within the current block are used. (Moreover, n2 line(s) of top neighboring reconstruction and/or m2 line(s) of left neighboring reconstruction are used.)
Here is an example of calculating a boundary matching cost. (n=2, m=2, n2=2, m2=2)

$$cost = {\sum }_{x = 0}^{block width} ( \vert a * {pred}_{x , 0} - b * {pred}_{x , 1} - c * - {reco}_{x , - 1} \vert + \vert d * {reco}_{x , - 1} - e * {pred}_{x , 0} - f * {reco}_{x , - 2} \vert ) + {\sum }_{y = o}^{block height} ( \vert g * {pred}_{0 , y} - h * {pred}_{1 , y} - i * {reco}_{- 1 , y} \vert + \vert j * {reco}_{- 1 , y} - k * {pred}_{0 , y} - l * {reco}_{- 2 , y} \vert )$$

where the weights (a, b, c, d, e, f, g, h, i, j, k, 1) can any positive integers such as a=2, b=1, c=1, d=2, e=1, f=1, g=2, h=1, i=1, j=2, k=1, 1=1.
Here is another example of calculating a boundary matching cost. (n=2, m=2, n2=1, m2=1)

$$cost = {\sum }_{x = o}^{b lock width} ( \vert a * {pred}_{x , 0} - b * {pred}_{x , 1} - c * {reco}_{x , - 1} \vert ) + {\sum }_{y = o}^{b lock height} ( \vert g * {pred}_{0 , y} - h * {pred}_{1 , y} - i * {reco}_{- 1 , y} \vert )$$

where the weights (a, b, c, g, h, i) can any positive integers such as a=2, b=1, c=1, g=2, h=1, i=1.
Here is another example of calculating a boundary matching cost. (n=1, m=1, n2=2, m2=2)

$$cost = {\sum }_{x = o}^{b lock width} ( \vert d * {reco}_{x , - 1} - e * {pred}_{x , 0} - f * {reco}_{x , - 2} \vert ) + {\sum }_{y = o}^{b lock height} ( \vert j * {reco}_{- 1 , y} - k * {pred}_{0 , y} - l * {reco}_{- 2 , y} \vert )$$

where the weights (d, e, f, j, k, 1) can any positive integers such as d=2, e=1, f=1, j=2, k=1, 1=1.
Here is another example of calculating a boundary matching cost. (n=1, m=1, n2=1, m2=1)

$$cost = {\sum }_{x = o}^{b lock width} \vert a * {pred}_{x , 0} - c * {reco}_{x , - 1} \vert + {\sum }_{y = o}^{b lock height} \vert g * {pred}_{0 , y} - i * {reco}_{- 1 , y} \vert$$

where the weights (a, c, g, i) can any positive integers such as a=1, c=1, g=1, i=1.
Here is another example of calculating a boundary matching cost. (n=2, m=1, n2=2, m2=1)

$$cost = {\sum }_{x = o}^{b lock width} ( \vert a * {pred}_{x , 0} - b * {pred}_{x , 1} - c * {reco}_{x , - 1} \vert + \vert d * {reco}_{x , - 1} - e * {pred}_{x , 0} - f * {reco}_{x , - 2} \vert ) + {\sum }_{y = o}^{b lock height} ( \vert g * {pred}_{0 , y} - i * {reco}_{- 1 , y} \vert )$$

where the weights (a, b, c, d, e, f, g, i) can any positive integers such as a=2, b=1, c=1, d=2, e=1, f=1, g=1, i=1.
Here is another example of calculating a boundary matching cost. (n=1, m=2, n2=1, m2=2)

$$cost = {\sum }_{x = o}^{b lock width} ( \vert a * {pred}_{x , 0} - c * {reco}_{x , - 1} \vert ) + {\sum }_{y = o}^{b lock height} ( \vert g * {pred}_{0 , y} - h * {pred}_{1 , y} - i * {reco}_{- 1 , y} \vert + \vert j * {reco}_{- 1 , y} - k * {pred}_{0 , y} - l * {reco}_{- 2 , y} \vert )$$

where the weights (a, c, g, h, i, j, k, 1) can any positive integers such as a=1, c=1, g=2, h=1, i=1, j=2, k=1, 1=1.
   (The following examples for n and m can also be applied to n2 and m2.)
   For another example, n can be any positive integer such as 1, 2, 3, 4, etc.
   For another example, m can be any positive integer such as 1, 2, 3, 4, etc.
   For another example, n and/or m vary with block width, height, or area.
One possible way is that, for a larger block (area>threshold2), m gets larger.
   Threshold2=64, 128, or 256.
   When area>threshold2, m is increased to 2. (Originally, m is 1.)
   When area>threshold2, m is increased to 4. (Originally, m is 1 or 2.)
Another possible way is that, for a taller block (height>threshold2*width), m gets larger and/or n gets smaller.
   Threshold2=1, 2, or 4.
   When height>threshold2*width, m is increased to 2. (Originally, m is 1.)
   When height>threshold2*width, m is increased to 4. (Originally, m is 1 or 2.)
Another possible way is that, for a larger block (area>threshold2), n gets larger.
   Threshold2=64, 128, or 256.
   When area>threshold2, n is increased to 2. (Originally, n is 1.)
   When area>threshold2, n is increased to 4. (Originally, n is 1 or 2.)
Another possible way is that, for a wider block (width>threshold2*height), n gets larger and/or m gets smaller.
   Threshold2=1, 2, or 4.
   When width>threshold2*height, n is increased to 2. (Originally, n is 1.)
   When width>threshold2*height, n is increased to 4. (Originally, n is 1 or 2.)

### LM Assisted Angular/Planar Mode

For traditional intra prediction modes (e.g. angular intra prediction modes, DC, and planar), the reference samples are from top and left neighboring reconstructed samples. Therefore, the accuracy of intra prediction decreases for right-bottom samples within the current block. In this section, LM (or cross-component mode(s)) is used to improve the prediction from traditional intra prediction modes.

In one embodiment, the current block's prediction is formed by a weighted sum of one or more hypotheses of predictions from traditional intra prediction mode(s) and one or more hypotheses of predictions from LM mode(s) (or cross-component mode(s)).
In one sub-embodiment, equal weights are applied to both.
In another sub-embodiment, weights vary with neighboring coding information, sample position, block width, height, mode or area.
   For example, when the sample position is far away from the top-left region, the weight for the prediction from traditional intra prediction modes decays.
More weighting schemes can reference “inverse LM” section.
   The following shows some examples.
One possible rule related to sample position is described as follows.
   When the sample position is further away from the reference samples, the weight for the prediction from other intra prediction modes (non-cross-component modes) decreases.
Another possible rule related to neighbouring coding information is described as follows.
   When more neighbouring blocks (left, above, left-above, right-above, and/or left-bottom) are coded with a particular (e.g. Mode A), the weight for the prediction from Mode A gets higher. For example, Mode A refers to a specific cross-component mode such as CCCM_LT or a specific cross-component family such as CCCM family (including CCCM_LT, CCCM_L, and/or CCCM_T) and/or CCLM family (including CCLM_LT, CCLM_L, and/or CCLM_T) and/or MMLM family (including MMLM_LT, MMLM_L, and/or MMLM_T). A weighting set is pre-defined to include multiple weighting candidates such as {1, 3}, {3, 1}, and/or equal weighting {2, 2} for one prediction from a traditional intra prediction mode and the other prediction from a cross-component mode. When all or most of the neighbouring blocks are coded by Mode A, the weighting candidate with a higher weight for the prediction from a cross-component mode is used. When only partial or one of the neighbouring blocks are coded by Mode A, the weighting candidate with an equal weighting is used. When few or none of the neighbouring blocks are coded by Mode A, the weighting candidate with a smaller weight for the prediction from a cross-component mode is used. For example, the neighbouring blocks include any subset of the coded blocks which are spatially adjacent to the top boundary or left boundary of the current block. In this case, the neighbouring blocks may refer to the top neighbouring block (located on the top of the top-right corner of the current block) and the left neighbouring block (located on the left of the bottom-left corner of the current block). For another example, the neighbouring blocks include any subset of the coded blocks located in a pre-defined range spatially nearing the top boundary or left boundary of the current block. In this case, the neighbouring blocks can be adjacent or non-adjacent to the current block.
Another possible rule related to sample position is described as follows.
   The current block is partitioned into several regions. The sample positions in the same region share the same weighting. If the current region is close to the reference L neighbour, the weight for prediction from other intra prediction modes (non-cross-component modes) is higher than the weight for prediction from CCLM (or a cross-component mode). The following shows some possible ways to partition the current block.
      (ratio of width and height close to or exactly 1:1): The distance between the current region and the left and top reference L neighbour is considered.
      (width>n*height, where n can be any positive integer): The distance between the current region and the top reference L neighbour is considered.
      (height>n*width, where n can be any positive integer): The distance between the current region and the left reference L neighbour is considered.

(*) The one or more LM mode(s) (or cross-component mode(s)) which will be used to generate the one or more hypotheses of predictions for LM assisted Angular/Planar Mode and/or inter CCLM and/or MH CCLM are selected from a pre-defined merging candidate list (called modelList). One modelIdx is signalled to select a candidate from the candidate list (modelList) and the selected candidate is used for the current block. The modelList contains one or more candidates where each candidate refers to a model (or cross-component mode) information. If only one candidate is in the list (the size of the list is only 1), the modellIdx is not signalled and/or can be inferred as 0 or a default value.

In one embodiment, when building modelList, one or more predefined candidates are added. The pre-defined candidates can include any subset/extension of the following candidates.
CCLM family: CCLM_LT, CCLM_L, CCLM_T
MMLM family: MMLM_LT, MMLM_L, MMLM_T
CCCM family: CCCM_LT, CCCM_L, CCCM_T

In another embodiment, when building modelList (a merge-like candidate list), one or more than one of the following candidate types are included.
Spatial model information from spatial neighbour blocks (corresponding to “Spatial MVP from spatial neighbour CUs” for inter)
Temporal model information from collocated blocks (corresponding to “Temporal MVP from collocated CUs” for inter)
History-based model information from a FIFO table (corresponding to “History-based MVP from a FIFO table” for inter)
Pairwise average model information (corresponding to “Pairwise average MVP” for inter)
Default model information (corresponding to “Zero MVs” for inter)

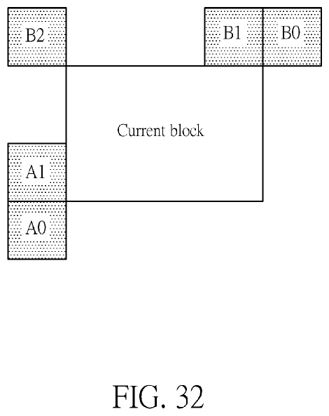

In one sub-embodiment of the candidate type being “Spatial model information from spatial neighbour blocks”, a valid spatial neighboring block(s) can be from one of spatial adjacent and/or non-adjacent neighbors (or any subset of the blocks in a neighboring search region for the current block) which satisfies a pre-defined condition. For example, the pre-defined condition is that the neighbor is encoded and/or decoded by or using a cross-component mode (such as CCLM, MMLM, CCCM, GLM, the mode with mode information inherited from a merge-like candidate list, MH CCLM, and/or any cross-component mode with syntax not belonging to tradition intra prediction modes) or cross-component-related mode (such as chroma fusion (or named LM assisted Angular/Planar Mode), inter CCLM, and/or any traditional mode with syntax not belonging to cross-component modes but using the cross-component information to generate the prediction). When scanning the spatial neighboring blocks, a candidate is added into the list if the candidate is valid. The following show some scanning orders when adding the Spatial model information from spatial neighbour blocks into the list.
For example, as illustrated in FIG. 32, the scanning order follows B1 (above)→A1 (left)→B0 (right-above)→A₀ (left-bottom)→B2 (left-above) or any pre-defined order.
For example, the scanning order follows adjacent candidates are prior to (or after) the non-adjacent candidates.

In another sub-embodiment of Temporal model information from collocated blocks, the collocated block is from the block in the reference picture or collocated picture as inter mode.

In another sub-embodiment of History-based model information, a history-based table (the FIFO table) is built and stores the model information from the previous coded blocks. The table can be reset as the beginning and/or end of a CTU, slice, picture, tile, and/or sequence. One or more than one candidates can be added into the list according to the table.

In another sub-embodiment of Pairwise average model information, the model information of this candidate is derived based on the model information from more than one of the previous candidates in the list.

In another sub-embodiment, the default model information is added if the list is not full after inserting all pre-defined candidates. Some examples of the default model information show below.
For example, the default alpha (or named as α, a, or scaling parameters) are {0, ⅛, −⅛, 2/8, − 2/8, ⅜}, and the beta (or named as β, b, or offset parameter) is based on the selected default alpha, average neighboring reconstructed luma sample value, and average neighboring reconstructed chroma (Cb/Cr) sample value.

In another sub-embodiment, when selecting one candidate from the list and using the model information from the candidate for the current block or when inheriting the model information from a previous coded block (when putting one candidate into the list), only a subset of the model information is inherited. For example, only the alpha is inherited. The beta is obtained for the current block through the inherited alpha, average neighboring reconstructed luma sample value, and/or average neighboring reconstructed chroma (Cb/Cr) sample value. For example of inheriting MMLM model information, the scaling parameters and/or the classification threshold are inherited. The offset parameter in each class is derived according to the inherited classification threshold and/or the average neighboring reconstructed luma sample value, and/or average neighboring reconstructed chroma (Cb/Cr) sample value in each class. If no neighboring reconstructed samples are available in a class, the offset parameter is directly inherited from the candidate. For example of inheriting CCCM model information, all convolution parameters, offsets, and/or the classification threshold are inherited. For example of inheriting GLM model information, if the GLM candidate is 3-parameter GLM mode, all the gradient pattern indices and model parameters are inherited; otherwise, if the GLM candidate is the 2-parameter GLM mode, the offset parameter is derived by using the inherited scaling parameter, average neighboring reconstructed luma sample value, and/or average neighboring reconstructed chroma (Cb/Cr) sample value. For example of inheriting chroma fusion model information, the derived MMLM parameters are inherited and used as when inheriting a MMLM candidate for the current block.

In another sub-embodiment, when selecting one candidate from the list and using the model information from the candidate for the current block, all model information is inherited. For example, both the alpha and beta are inherited.

In another sub-embodiment, the to-be-propagated mode for the current block (using chroma fusion or named as LM assisted Angular/Planar Mode, inter CCLM, or MH CCLM) is set/stored as the inherited mode, referring to any cross-component mode and/or any cross-component model and/or any subset of cross-component model information used for the current block, such as CCLM, MMLM, CCCM, and/or GLM.

In another sub-embodiment, the candidate types are aligned with the candidate types for the merge mode.

In another sub-embodiment, when building the list, pruning operations are applied to avoiding duplicated candidates in the list.

In another sub-embodiment, the signalling of the modelIdx for the current block depends on context coding, block width, block height, block area, and/or explicit syntax such as SPS, PPS, slice, CTU, picture, sequence, and/or tile level signalling.

In another sub-embodiment, the candidate selection (from the list) for the current block depends on a pre-defined process. For example, the pre-defined process is a TIMD or DIMD-like method. When the pre-defined process refers to TIMD-like method, (1) a cost for each candidate in the list is calculated based on the distortion of the reconstructed samples on the neighboring template and the predicted samples from this candidate on the neighboring template (2) one or more candidates with smaller costs (or smaller distortions) are selected and/or (3) the one or more selected candidates are used to generate the cross-component prediction of the current block. For example, the pre-defined process depends on the neighboring template of the current block. For example, the pre-defined process depends on the mode information on the neighboring blocks. If most of the pre-defined neighboring blocks use a specific mode, the first candidate (in the list) referring to the specific mode is selected. The signalling of the modelIdx is bypass (not required for signalling).

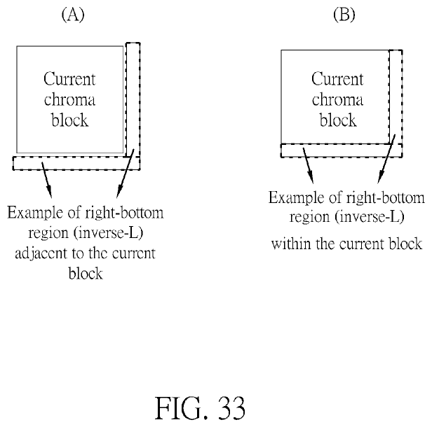

In another embodiment, it is proposed to use LM mode to generate the right-bottom region within or nearing the current block. When doing intra prediction, the reference samples can be based on not only original left and top neighboring reconstructed samples but also proposed right and bottom LM-predicted samples. The following shows an example.
Before doing intra prediction for a chroma block, the collocated luma block is reconstructed.
“The neighboring luma reconstructed samples of the collocated luma block” and “the neighboring chroma reconstructed samples of the current chroma block” are used for deriving LM parameters.
“The reconstructed samples of the collocated luma block” with the derived parameters are used for obtaining the right-bottom LM-predicted samples of the current chroma block. (Right-bottom region of the current chroma block can be any subset of the region in FIG. 33)
The prediction of the current block is generated bi-directionally by referencing original L neighboring region (original top and left region, obtained using a traditional intra prediction mode) and proposed inverse-L region (obtained using LM).

In one sub-embodiment, the predictors from the original top and left region and the predictors from bottom and left region are combined with weighting.
In one example, equal weights are applied to both.
In one example, weights vary with neighboring coding information, sample position, block width, height, mode or area.
e.g., when the sample position is far from the top and left region, the weight for the prediction from the traditional intra prediction mode decays.

In another embodiment, this proposed method can be applied to inverse LM. Then, when doing luma intra prediction, the final prediction is bi-directional. (similar to the above example for a chroma block)

In another embodiment, after doing segmentation to know the curve pattern for luma, the proposed LM assisted Angular/Planar Mode assists chroma with getting the correct curved angle.

The proposed methods in this invention can be enabled and/or disabled according to implicit rules (e.g. block width, height, or area) or according to explicit rules (e.g. syntax on block, slice, picture, sps, or pps level).

The term “block” in this invention can refer to TU/TB, CU/CB, PU/PB, or CTU/CTB.

The term “LM” in this invention can be viewed as one kind of CCLM/MMLM modes or any other extension/variation of CCLM (e.g. the proposed CCLM extension/variation in this invention). The variations of CCLM here mean that some optional modes can be selected when the block indication refers to using one of cross-component modes (e.g. CCLM_LT, MMLM_LT, CCLM_L, CCLM_T, MMLM_L, MMLM_T, and/or an intra prediction mode, which is not one of traditional DC, planar, and angular modes) for the current block. The following shows an example of being convolutional cross-component mode (CCCM) as an optional mode. When this optional mode is applied to the current block, cross-component information with a model, which may include a non-linear term, is used to generate the chroma prediction. The optional mode may follow the template selection of CCLM, so CCCM family includes CCCM_LT CCCM_L, and/or CCCM_T.

The proposed methods (for CCLM) in this invention can be used for any other LM modes.

Any combination of the proposed methods in this invention can be applied.

Any of the foregoing proposed methods can be implemented in encoders and/or decoders. For example, any of the proposed methods can be implemented in an intra/inter/IBC coding module of an encoder and/or decoder, and/or a motion compensation module and/or a merge candidate derivation module of an encoder and/or decoder. Alternatively, any of the proposed methods can be implemented as a circuit coupled to the intra/inter/IBC coding module of an encoder and/or decoder, and/or motion compensation module and/or a merge candidate derivation module of the encoder and/or decoder.

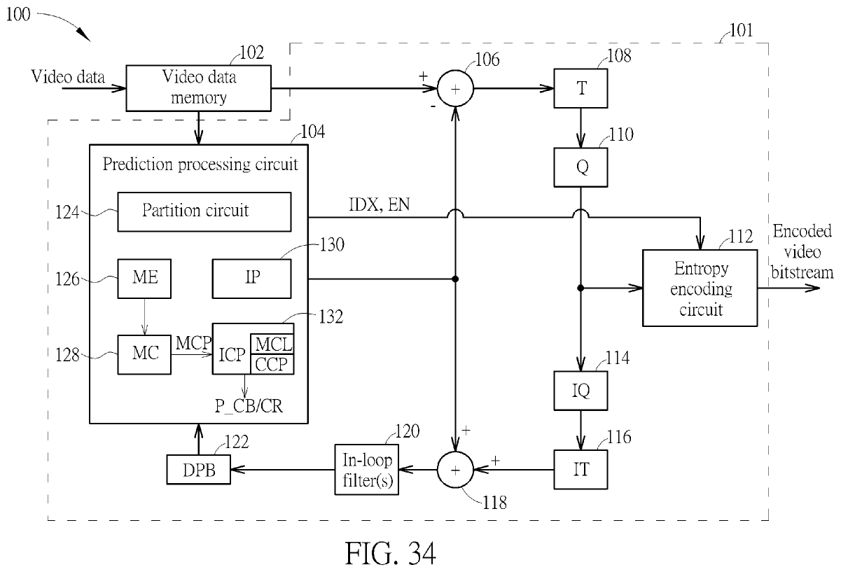

FIG. 34 is a block diagram illustrating a video encoder that supports the proposed inter chroma prediction mode according to an embodiment of the present invention. By way of example, but not limitation, the video encoder 100 may be a VVC encoder. The video encoder 100 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence. The proposed inter chroma prediction mode is a coding tool for chroma samples in a chroma block, and uses at least one cross-component predictor (which is an intra predictor) to improve accuracy of a motion compensation predictor (which is an inter predictor).

As shown in FIG. 34, the video encoder 100 includes an encoding circuit 101 and a video data memory 102. The video data memory 102 is arranged to receive data to be encoded as a current block of pixels of a current picture of a video, wherein the current block includes at least one chroma block. The encoding circuit 101 is arranged to perform encoding of the current block by a target inter prediction mode. The encoding circuit 101 may include a prediction processing circuit 104, a residual generation circuit 106, a transform circuit (labeled by “T”) 108, a quantization circuit (labeled by “Q”) 110, an entropy encoding circuit (e.g., a variable-length code (VLC) encoder) 112, an inverse transform circuit (labeled by “IQ”) 114, an inverse transform circuit (labeled by “IT”) 116, a reconstruction circuit 118, one or more in-loop filters 120, and a decoded picture buffer (DPB) 122. It should be noted that the encoder architecture shown in FIG. 34 is for illustrative purposes only, and is not meant to be a limitation of the present invention. In practice, any video encoder using/supporting the proposed inter chroma prediction mode falls within the scope of the present invention.

The prediction processing circuit 104 may include a partition circuit 124, a motion estimation circuit (labeled by “ME”) 126, a motion compensation circuit (labeled by “MC”) 128, an intra prediction circuit (labeled by “IP”) 130, and an inter chroma prediction circuit (labeled by “ICP”) 132. The proposed inter chroma prediction mode is supported by the prediction processing circuit 104 (particularly, inter chroma prediction circuit 132 of prediction processing circuit 104). As the present invention is focused on the proposed inter chroma prediction mode and a person skilled in the art should readily understand details of other circuit components included in the video encoder 100, further description of principles of other circuit components included in the video encoder 100 is omitted here for brevity.

The motion compensation circuit 128 of the prediction processing circuit 104 is arranged to obtain a motion compensation predictor MCP of a chroma sample included in a chroma block (e.g., a Cr block or a Cb block). For example, the motion estimation circuit 126 may determine a motion vector of a luma block in the same coding unit according to a selected inter prediction mode, and the motion vector of the luma block may be directly inherited by the chroma block in the same coding unit. Hence, the motion compensation circuit 128 may refer to the motion vector of the luma block to determine the motion compensation predictor (which is an inter predictor) MCP of the chroma sample included in the chroma block. However, this is for illustrative purposes only, and is not meant to be a limitation of the present invention. In practice, any inter prediction means capable of obtaining the motion compensation predictor MCP of a chroma sample included in a chroma block (e.g., a Cr block or a Cb block) can be employed by the prediction processing circuit 104.

The inter chroma prediction circuit 132 is arranged to obtain at least one (i.e., one or more) cross-component predictor CCP of the chroma sample, and determine inter prediction of the chroma sample (e.g., a final predictor P_CB/CR) by jointly considering the motion compensation predictor MCP and the cross-component predictor(s) CCP. For example, the inter chroma prediction circuit 132 blends the motion compensation predictor MCP and the cross-component predictor(s) CCP to generate a weighted predictor as the inter prediction of the chroma sample. In some embodiments of the present invention, the cross-component predictor(s) CCP to be blended with the motion compensation predictor MCP may include a CCLM-based predictor and/or a predictor generated using any cross-component mode. In some embodiments of the present invention, the motion compensation predictor MCP and the cross-component predictor CCP may be blended using pre-defined (fixed) weighting such as {3:1} or {1:3}.

Regarding generation of the cross-component predictor CCP, the inter chroma prediction circuit 132 may construct a merge candidate list MCL for cross-component prediction, and determine the cross-component predictor CCP according to a cross-component model candidate selected from the merge candidate list MCL. In some embodiments of the present invention, the candidate types may be aligned with that used by inter motion merge candidate list, or may be a subset of that used by inter motion merge candidate list. The difference between the merge candidate list MCL and the inter motion merge candidate list is that the merge candidate list MCL includes inherited cross-component models, while the inter motion merge candidate list includes inherited motion information.

For example, the merge candidate list MCL may include spatial candidates. Specifically, the inter chroma prediction circuit 132 may add a cross-component model located at a spatial neighboring position to the merge candidate list MCL. The spatial neighboring position and a sample position of the chroma sample are located at the same frame. The spatial neighboring position may be an adjacent position or a non-adjacent position with respect to the boundary of the current chroma block.

For another example, the merge candidate list MCL may include temporal candidates. Specifically, the inter chroma prediction circuit 132 may add a cross-component model located at a temporal collocated position to the merge candidate list MCL. The temporal collocated position and a sample position of the chroma sample are located at the same position in different frames.

For another example, the merge candidate list MCL may include history-based candidates. Specifically, the inter chroma prediction circuit 132 may add a cross-component model from a history table to the merge candidate list MCL, wherein the history table may be implemented by a first-in first-out (FIFO) buffer that contains cross-component models of previously coded chroma blocks (i.e., previous chroma blocks that are encoded before the current chroma block).

For another example, the merge candidate list MCL may include default candidates. Specifically, the inter chroma prediction circuit 132 may add a default cross-component model (i.e., pre-defined cross-component model) to the merge candidate list MCL.

In some embodiments of the present invention, after the inter chroma prediction circuit 132 selects a cross-component model candidate from the merge candidate list MCL for follow-up computation of the cross-component predictor CCP, the inter chroma prediction circuit 132 may output a mode index IDX to the entropy encoding circuit 112, such that the mode index IDX is encoded into the encoded video bitstream output from the video encoder 100. Specifically, the data to be encoded as the current block of pixels of the current picture of the video includes a syntax for a mode index to indicate selection of the cross-component model candidate. For example, the mode index IDX is signalled to indicate selection of the cross-component model candidate at the video encoder 100. Alternatively, selection of the cross-component model candidate may be implicitly derived without any mode index signalling. For example, the inter chroma prediction circuit 132 may employ an implicit derivation manner similar to that employed by TIMD. Specifically, the inter chroma prediction circuit 132 uses reference samples of a neighboring template to calculate a template matching (TM) cost for each cross-component model candidate included in the merge candidate list MCL, and select one of cross-component model candidates included in the merge candidate list MCL that has a minimum TM cost as the cross-component model candidate used for obtaining the cross-component predictor CCP. Since both of the video encoder and the video decoder follow the same template-based manner to select a cross-component model candidate from the same merge candidate list MCL constructed at both of the video encoder and the video decoder, no signalling of the mode index IDX from the video encoder to the video decoder is needed. In this way, signalling overhead can be reduced.

As mentioned above, when the proposed inter chroma prediction is enabled, the inter chroma prediction circuit 132 uses the cross-component predictor CCP to improve accuracy of the inter predictor (e.g., motion compensation predictor MCP). In some embodiments of the present invention, the proposed inter chroma prediction mode is not enabled by the prediction processing circuit 104 unless all enabling conditions are satisfied. For example, the enabling conditions may include a size condition of the chroma block, where the size condition may be defined by a block height, a block width, and/or a block area. Hence, when the block height and/or width and/or area is smaller than (or larger than) a pre-defined threshold, the size condition is satisfied.

For another example, the enabling conditions may include supported prediction modes of the chroma block, where the supported prediction modes may include inter modes only or any sub-mode of inter modes. Hence, when a selected prediction mode for determining the motion compensation predictor MCP is one of the supported inter modes (or any sub-mode of supported inter modes), the prediction mode condition is satisfied.

Furthermore, when all enabling conditions are satisfied, the data to be encoded as the current block of pixels of the current picture of the video includes a flag to indicate to apply the target inter prediction mode. For example, when all enabling conditions are satisfied, the inter chroma prediction circuit 132 sets a flag EN (e.g., EN=1) to indicate to apply the proposed inter chroma prediction mode, and outputs the flag EN (e.g., EN=1) to the entropy encoding circuit 112. Hence, the entropy encoding circuit 112 encodes the flag EN (e.g., EN=1) into the encoded video bitstream. In this way, the flag EN (e.g., EN=1) is signalled from the video encoder 100 to the video decoder via the encoded video bitstream. When the proposed inter chroma prediction is not enabled, the flag EN is not signalled by the encoder and/or is inferred at the encoder.

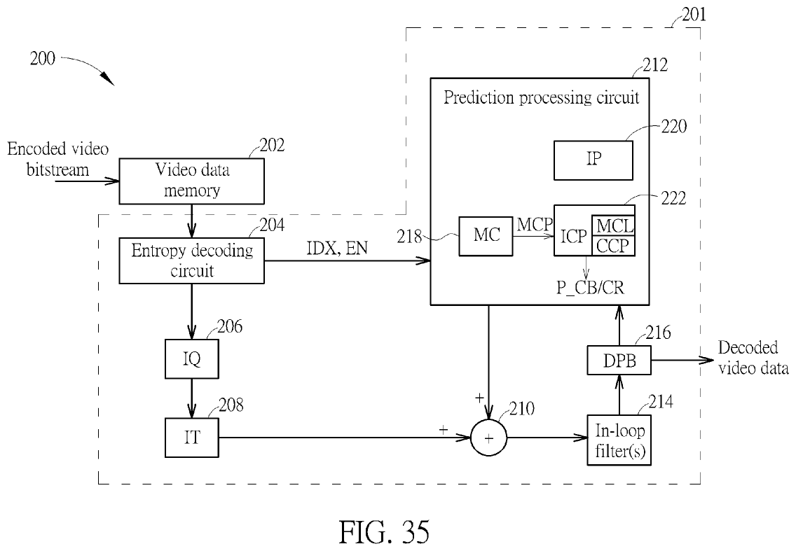

FIG. 35 is a block diagram illustrating a video decoder that supports the proposed inter chroma prediction mode according to an embodiment of the present invention. By way of example, but not limitation, the video decoder 200 may be a VVC decoder. The video decoder 200 includes a decoding circuit 201 and a video data memory 202. The video data memory 202 is arranged to receive data to be decoded as a current block of pixels of a current picture of a video, wherein the current block includes at least one chroma block. The decoding circuit 201 is arranged to perform decoding of the current block by a target inter prediction mode. The decoding circuit 201 may include an entropy decoding circuit (e.g., a VLC decoder) 204, an inverse quantization circuit (labeled by “IQ”) 206, an inverse transform circuit (labeled by “IT”) 208, a reconstruction circuit 210, a prediction processing circuit 212, one or more in-loop filters 214, and a decoded picture buffer (DPB) 216. It should be noted that the decoder architecture shown in FIG. 35 is for illustrative purposes only, and is not meant to be a limitation of the present invention. In practice, any video decoder using/supporting the proposed inter chroma prediction mode falls within the scope of the present invention.

The prediction processing circuit 212 may include a motion compensation circuit (labeled by “MC”) 218, an intra prediction circuit (labeled by “IP”) 220, and an inter chroma prediction circuit (labeled by “ICP”) 222. The proposed inter chroma prediction mode is supported by the prediction processing circuit 212 (particularly, inter chroma prediction circuit 222 of prediction processing circuit 212). As the present invention is focused on the proposed inter chroma prediction mode and a person skilled in the art should readily understand details of other circuit components included in the video decoder 200, further description of principles of other circuit components included in the video decoder 200 is omitted here for brevity.

The motion compensation circuit 218 of the prediction processing circuit 212 is arranged to obtain a motion compensation predictor (which is an inter predictor) MCP of a chroma sample included in a chroma block (e.g., a Cr block or a Cb block). The motion vector used by the decoder-side motion compensation circuit 218 for obtain the motion compensation predictor MCP is the same as that used by the encoder-side motion compensation circuit 128 for obtain the motion compensation predictor MCP.

Functions of the decoder-side inter chroma prediction circuit 222 are similar/identical to that of the encoder-side inter chroma prediction circuit 132. The inter chroma prediction circuit 222 is arranged to obtain at least one (i.e., one or more) cross-component predictor (which is an intra predictor) CCP of the chroma sample, and determine inter prediction of the chroma sample (e.g., a final predictor P_CB/CR) by jointly considering the motion compensation predictor MCP and the cross-component predictor(s) CCP. For example, the inter chroma prediction circuit 222 blends the motion compensation predictor MCP and the cross-component predictor(s) CCP to generate a weighted predictor as the inter prediction of the chroma sample. In some embodiments of the present invention, the cross-component predictor(s) CCP may include a

CCLM-based predictor and/or a predictor generated using any cross-component mode. In some embodiments of the present invention, the motion compensation predictor MCP and the cross-component predictor CCP may be blended using pre-defined (fixed) weighting such as {3:1} or {1:3}.

Regarding generation of the cross-component predictor CCP, the inter chroma prediction circuit 222 may construct a merge candidate list MCL for cross-component prediction, and determine the cross-component predictor CCP according to a cross-component model candidate selected from the merge candidate list MCL. In some embodiments of the present invention, the candidate types may be aligned with that used by inter motion merge candidate list, or may be a subset of that used by inter motion merge candidate list. The merge candidate list MCL constructed by the decoder-side inter chroma prediction circuit 222 is the same as that constructed by the encoder-side inter chroma prediction circuit 132.

For example, the merge candidate list MCL may include spatial candidates. Specifically, the inter chroma prediction circuit 222 may add a cross-component model located at a spatial neighboring position to the merge candidate list MCL. The spatial neighboring position and a sample position of the chroma sample are located at the same frame. The spatial neighboring position may be an adjacent position or a non-adjacent position with respect to the boundary of the current chroma block.

For another example, the merge candidate list MCL may include temporal candidates. Specifically, the inter chroma prediction circuit 222 may add a cross-component model located at a temporal collocated position to the merge candidate list MCL. The temporal collocated position and a sample position of the chroma sample are located at the same position in different frames.

For another example, the merge candidate list MCL may include history-based candidates. Specifically, the inter chroma prediction circuit 222 may add a cross-component model from a history table to the merge candidate list MCL, wherein the history table may be implemented by a first-in first-out (FIFO) buffer that contains cross-component models of previously coded chroma blocks (i.e., previous chroma blocks that are decoded before the current chroma block).

For another example, the merge candidate list MCL may include default candidates. Specifically, the inter chroma prediction circuit 222 may add a default cross-component model (i.e., pre-defined cross-component model) to the merge candidate list MCL.

In a case where a mode index IDX (which indicates selection of the cross-component model candidate) is signalled from a video encoder (e.g., video encoder 100) to the video decoder 200, the entropy decoding circuit 204 may parse the mode index IDX from the encoded video bitstream, and informs the prediction processing circuit 212 (particularly, inter chroma prediction circuit 222 of prediction processing circuit 212) of the mode index IDX. Specifically, the data to be decoded as the current block of pixels of the current picture of the video includes a syntax for a mode index to indicate selection of the cross-component model candidate. For example, the inter chroma prediction circuit 222 refers to the signalled mode index IDX to select the same cross-component model candidate used by the video encoder (e.g., video encoder 100) from the merge candidate list MCL.

Alternatively, selection of the cross-component model candidate may be implicitly derived without parsing any signalled mode index from the encoded video bitstream. For example, the inter chroma prediction circuit 222 may employ an implicit derivation manner similar to that employed by TIMD. Specifically, the inter chroma prediction circuit 222 uses reference samples of a neighboring template to calculate a cost for each cross-component model candidate included in the merge candidate list MCL, and select one of cross-component model candidates included in the merge candidate list MCL that has a minimum cost as the cross-component model candidate used for obtaining the cross-component predictor CCP. Since both of the video encoder and the video decoder follow the same template-based manner to select a cross-component model candidate from the same merge candidate list MCL constructed at both of the video encoder and the video decoder, no signalling of the mode index IDX from the video encoder to the video decoder is needed, and no parsing of the signalled mode index IDX at the video decoder is needed. In this way, signalling overhead can be reduced.

As mentioned above, when the proposed inter chroma prediction is enabled, the inter chroma prediction circuit 222 uses the cross-component predictor CCP to improve accuracy of the inter predictor (e.g., motion compensation predictor MCP). In some embodiments of the present invention, the proposed inter chroma prediction mode is not enabled by the prediction processing circuit 212 unless all enabling conditions are satisfied. For example, the enabling conditions may include a size condition of the chroma block, where the size condition may be defined by a block height, a block width, and/or a block area. Hence, when the block height and/or width and/or area is smaller than (or larger than) a pre-defined threshold, the size condition is satisfied.

For another example, the enabling conditions may include supported prediction modes of the chroma block, where the supported prediction modes may include inter modes only or any sub-mode of inter modes. Hence, when a selected prediction mode for determining the motion compensation predictor MCP is one of the supported inter modes (or any sub-mode of supported inter modes), the prediction mode condition is satisfied.

Furthermore, when the proposed inter chroma prediction is enabled, for example, due to all enabling conditions being satisfied, the data to be decoded as the current block of pixels of the current picture of the video includes a flag to indicate to apply the target inter prediction mode. For example, when the proposed inter chroma prediction is enabled, the inter chroma prediction circuit 222 uses the cross-component predictor CCP to improve accuracy of the inter predictor (e.g., motion compensation predictor MCP). In a case where a flag EN (e.g., EN=1) is signalled from a video encoder (e.g., video encoder 100) to the video decoder 200, the entropy decoding circuit 204 parses the flag EN (e.g., EN=1) from the encoded video bitstream, and informs the prediction processing circuit 212 (particularly, inter chroma prediction circuit 222 of prediction processing circuit 212) of the flag EN (e.g., EN=1). Hence, the proposed inter chroma prediction mode is enabled by the prediction processing circuit 212 in response to the flag EN (e.g., EN=1) that indicates to apply the proposed inter chroma prediction mode. When the proposed inter chroma prediction is not enabled, the flag EN is not signalled to the decoder and/or is not parsed from the decoder and/or is inferred at the decoder.

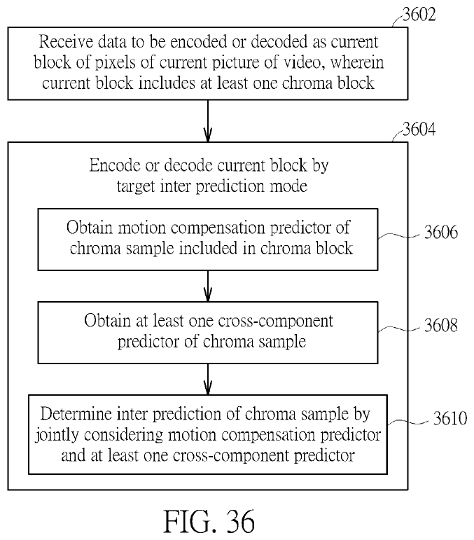

FIG. 36 is a flowchart illustrating a video coding method according to an embodiment of the present invention. The video coding method may be employed by the video encoder 100 shown in FIG. 34 for encoding of video data or the video decoder 200 shown in FIG. 35 for decoding of encoded video bitstream. Provided that the result is substantially the same, the steps are not required to be executed in the exact order shown in FIG. 36. At step 3602, data to be encoded or decoded is received as a current block of pixels of a current picture of a video, wherein the current block includes at least one chroma block. At step 3604, encoding or decoding of the current block is performed by a target inter prediction mode. The step 3604 includes sub-steps 3606, 3608, and 3610. At sub-step 3606, a motion compensation predictor of a chroma sample included in the at least one chroma block is obtained. At sub-step 3608, at least one cross-component predictor of the chroma sample is obtained. At sub-step 3610, inter prediction of the chroma sample is determined by jointly considering (e.g., blending) the motion compensation predictor and the at least one cross-component predictor. As a person skilled in the art can readily understand details of the video coding method after reading above paragraphs with reference to the accompanying drawings, further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for video coding, comprising:
receiving data to be encoded or decoded as a current block of pixels of a current picture of a video, wherein the current block comprises at least one chroma block; and
encoding or decoding the current block by a target inter prediction mode, comprising:
obtaining a motion compensation predictor of a chroma sample included in the at least one chroma block;
obtaining at least one cross-component predictor of the chroma sample; and
determining inter prediction of the chroma sample by jointly considering the motion compensation predictor and the at least one cross-component predictor.

2. The method of claim 1, wherein the at least one cross-component predictor comprises a cross component linear model (CCLM) based predictor.

3. The method of claim 1, wherein obtaining the at least one cross-component predictor of the chroma sample comprises:
constructing a merge candidate list for cross-component prediction; and
determining the at least one cross-component predictor according to a cross-component model candidate selected from the merge candidate list.

4. The method of claim 3, wherein constructing the merge candidate list for cross-component prediction comprises:
adding a cross-component model located at a spatial neighboring position to the merge candidate list.

5. The method of claim 3, wherein constructing the merge candidate list for cross-component prediction comprises:
adding a cross-component model located at a temporal collocated position to the merge candidate list.

6. The method of claim 3, wherein constructing the merge candidate list for cross-component prediction comprises:
adding a cross-component model from a history table to the merge candidate list, wherein the history table contains cross-component models of previously coded chroma blocks.

7. The method of claim 3, wherein constructing the merge candidate list for cross-component prediction comprises:
adding a default cross-component model to the merge candidate list.

8. The method of claim 3, wherein the data to be encoded as the current block of pixels of the current picture of the video comprises a syntax for a mode index to indicate selection of the cross-component model candidate.

9. The method of claim 3, wherein the data to be decoded as the current block of pixels of the current picture of the video comprises a syntax for a mode index to indicate selection of the cross-component model candidate.

10. The method of claim 3, wherein determining the at least one cross-component predictor according to the cross-component model candidate selected from the merge candidate list comprises:
using reference samples of a neighboring template to calculate a cost for each cross-component model candidate included in the merge candidate list; and
selecting one of cross-component model candidates included in the merge candidate list that has a minimum cost as the cross-component model candidate used for obtaining the at least one cross-component predictor.

11. The method of claim 1, wherein determining the inter prediction of the chroma sample by jointly considering the motion compensation predictor and the at least one cross-component predictor comprises:
blending the motion compensation predictor and the at least one cross-component predictor to generate a weighted predictor as the inter prediction of the chroma sample.

12. The method of claim 11, wherein the at least one cross-component predictor comprises a cross component linear model (CCLM) based predictor.

13. The method of claim 11, wherein the motion compensation predictor and the at least one cross-component predictor are blended using pre-defined weighting.

14. The method of claim 1, wherein the target inter prediction mode is enabled in response to all enabling conditions being satisfied.

15. The method of claim 14, wherein the enabling conditions comprise a size condition of the at least one chroma block.

16. The method of claim 14, wherein the enabling conditions comprise supported prediction modes of the at least one chroma block.

17. The method of claim 14, wherein in response to all enabling conditions being satisfied, the data to be encoded as the current block of pixels of the current picture of the video comprises a flag to indicate to apply the target inter prediction mode.

18. The method of claim 1, wherein in response to all enabling conditions being satisfied, the data to be decoded as the current block of pixels of the current picture of the video comprises a flag to indicate to apply the target inter prediction mode.

19. A video encoder, comprising:
a video data memory, arranged to receive data to be encoded as a current block of pixels of a current picture of a video, wherein the current block comprises at least one chroma block; and
an encoding circuit, arranged to perform encoding of the current block by a target inter prediction mode, wherein the encoding circuit comprises:
a motion compensation circuit, arranged to obtain a motion compensation predictor of a chroma sample included in the at least one chroma block; and
an inter chroma prediction circuit, arranged to obtain at least one cross-component predictor of the chroma sample, and determine inter prediction of the chroma sample by jointly considering the motion compensation predictor and the at least one cross-component predictor.

20. A video decoder, comprising:
a video data memory, arranged to receive data to be decoded as a current block of pixels of a current picture of a video, wherein the current block comprises at least one chroma block; and
a decoding circuit, arranged to perform decoding of the current block by a target inter prediction mode, wherein the decoding circuit comprises:
a motion compensation circuit, arranged to obtain a motion compensation predictor of a chroma sample included in the at least one chroma block; and
an inter chroma prediction circuit, arranged to obtain at least one cross-component predictor of the chroma sample, and determine inter prediction of the chroma sample by jointly considering the motion compensation predictor and the at least one cross-component predictor.
